(19) United States
(12) Patent Application Publication
(10) Pub. No.: US 2012/0146809 A1
(43) Pub. Date: Jun. 14, 2012

(54) INFORMATION PROVIDING APPARATUS AND METHOD FOR VEHICLES

(75) Inventors: Chang Yoon OH, Suwon-si (KR); Hee Jeong LEE, Suwon-si (KR)

(73) Assignee: SAMSUNG ELECTRONICS CO. LTD., Suwon-si (KR)

(21) Appl. No.: 13/324,323

(22) Filed: Dec. 13, 2011

(30) Foreign Application Priority Data
Dec. 13, 2010 (KR) 10-2010-0126782
Dec. 13, 2010 (KR) 10-2010-0126783

(51) Int. Cl. G08G 1/00

(52) U.S. Cl. 340/901

(57) ABSTRACT

An information providing apparatus and method for vehicles are provided. The information providing method includes determining a vehicle state based on sensing signals from one or more sensors installed on a vehicle, generating state information through analysis of the vehicle state, and transmitting the state information to a second vehicle. Hence, other vehicles may reduce their driving speed or change their course of driving according to received vehicle state information.

### PRIORITY

This application claims the benefit under 35 U.S.C. §119(a) of a Korean patent application filed on Dec. 13, 2010 in the Korean Intellectual Property Office and assigned Serial No. 10-2010-0126782, and of a Korean patent application filed on Dec. 13, 2010 in the Korean Intellectual Property Office and assigned Serial No. 10-2010-0126783, the entire disclosure of each of which is hereby incorporated by reference.

### BACKGROUND OF THE INVENTION

1. Field of the Invention

The present invention relates to an information providing apparatus and method for a vehicle. More particularly, the present invention relates to an information providing apparatus and method for providing vehicle state information to other vehicles.

2. Description of the Related Art

When a vehicle is driven or stopped, one or more installed sensors may sense vehicle states with respect to, for example, the engine, transmission, braking and airbag, and transmit the sensed state information to an Electronic Control Unit (ECU).

When the vehicle is parked, similar to the case of driving, one or more sensors may sense vehicle states with respect to, for example, a burglar alarm and a minor collision, and transmit the sensed state information to the ECU.

When a traffic accident occurs while the vehicle is driven, at least one sensor such as a collision detection sensor and an airbag sensor may be activated, and activation results may be transmitted to the ECU.

When a vehicle is involved in an accident, an emergency handling vehicle such as an ambulance or a wrecker may be needed, and the driver of the vehicle or other drivers near the site of the accident may make a call using an emergency telephone number like 911.

Drivers of other vehicles passing the site of an accident may reduce traveling speed to prevent a car accident.

Drivers of other vehicles distant from the site of an accident may be unable to be aware of the accident. When a car accident occurs in a road section, other vehicles passing the road section may encounter stop and go traffic.

Therefore, there is a need for an apparatus and method that provides state information to other vehicles.

### SUMMARY OF THE INVENTION

Aspects of the present invention are to address at least the above-mentioned problems and/or disadvantages and to provide at least the advantages described below. Accordingly, an aspect of the present invention is to provide an information providing apparatus and method for a vehicle wherein the vehicle can provide vehicle state information to other vehicles through wireless communication.

In accordance with an aspect of the present invention, an information providing method for vehicles is provided. The method includes determining a vehicle state based on sensing signals from one or more sensors installed on a vehicle, generating state information through analysis of the vehicle state, and transmitting the state information to a second vehicle.

In accordance with another aspect of the present invention, an information providing apparatus for a vehicle is provided. The apparatus includes one or more sensors for generating sensing signals for the vehicle, an Electronic Control Unit (ECU) for determining a vehicle state based on the sensing signals from the sensors, and a black box for generating state information through analysis of the vehicle state and transmitting the state information to a second vehicle.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates various sensors in a vehicle according to an exemplary embodiment of the present invention;

FIGS. 2A to 2E are block diagrams of a vehicle, a server, an emergency center, and a second vehicle according to an exemplary embodiment of the present invention;

FIGS. 3A and 3B are flowcharts of information providing methods of a vehicle and a server according to an exemplary embodiment of the present invention;

FIGS. 4A to 4C illustrate user interface screens for providing vehicle information according to an exemplary embodiment of the present invention;

FIG. 5 illustrates a driving direction table according to an exemplary embodiment of the present invention;

FIGS. 6A and 6B illustrate traffic information tables created and updated by a server according to an exemplary embodiment of the present invention;

FIG. 7 illustrates status information regarding emergency actions generated by an emergency center according to an exemplary embodiment of the present invention;

FIGS. 8A and 8B illustrate messages received by a vehicle and a vehicle according to an exemplary embodiment of the present invention;

FIG. 9 illustrates a brake system of a vehicle according to an exemplary embodiment of the present invention;

FIG. 10 is a block diagram of vehicles according to an exemplary embodiment of the present invention;

FIG. 11 is a flowchart of a warning providing method for a vehicle according to an exemplary embodiment of the present invention;

FIGS. 12A and 12B illustrate user interface screens for setting a warning providing method according to an exemplary embodiment of the present invention;

FIG. 13 illustrates a transmission frequency table according to an exemplary embodiment of the present invention; and

FIGS. 14A to 14C illustrate provision of warning messages to drivers of other vehicles according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

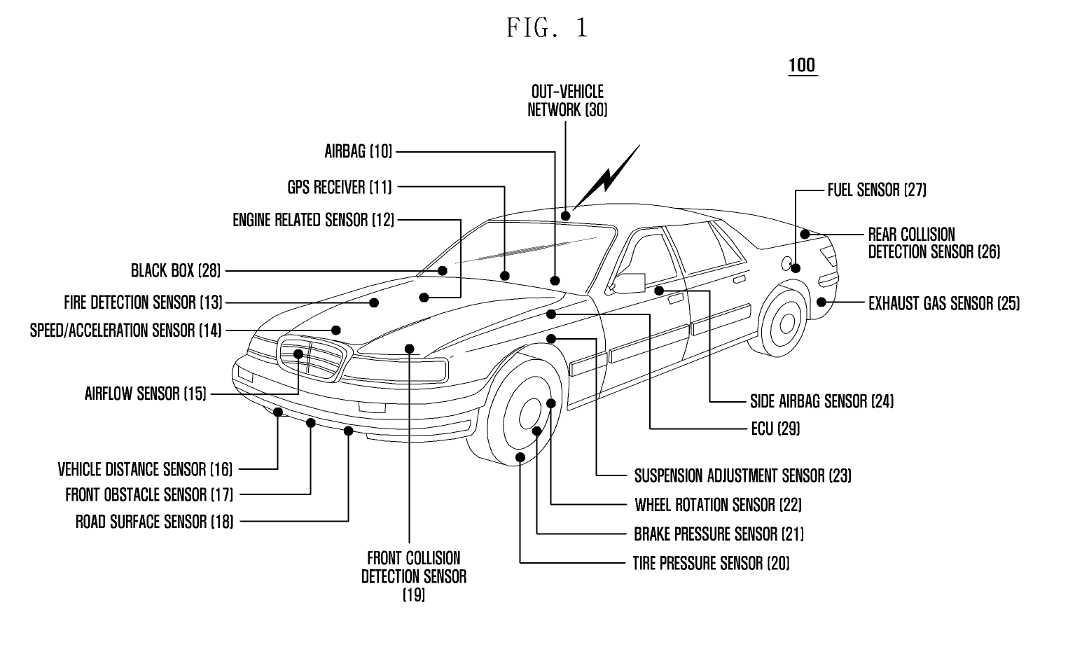

FIG. 1 illustrates various sensors in a vehicle according to an exemplary embodiment of the present invention.

FIG. 1 illustrates various types of sensors installed in the vehicle 100, such as sensors 12 and 13 for sensing temperature, sensors 20 and 21 for sensing pressure, a sensor 15 for sensing air flow, a sensor 25 for sensing gas concentration, a sensor 22 for sensing wheel rotation, sensors 10, 19, 24 and 26 for sensing vibration or shock, a sensor 11 for sensing location, a sensor 23 for sensing angles, sensors 16 and 17 for sensing distances, a sensor 27 for sensing liquid levels, a sensor 18 for sensing the road surface, and a sensor 14 for sensing acceleration.

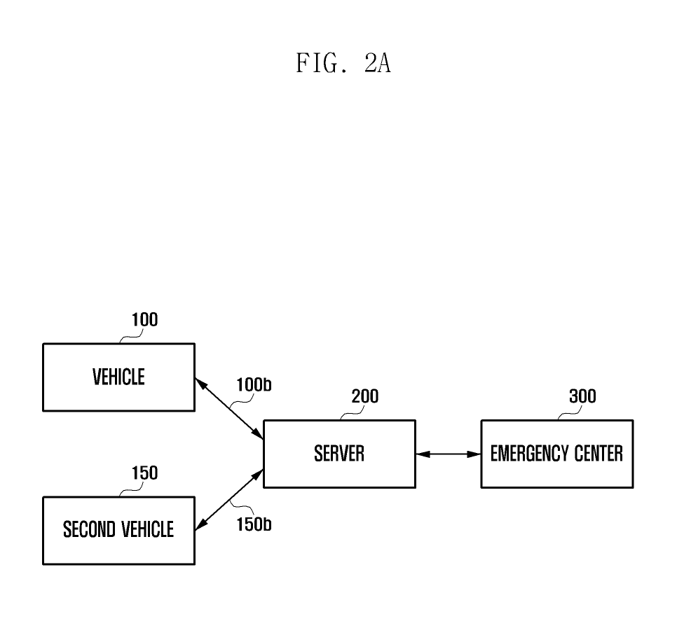

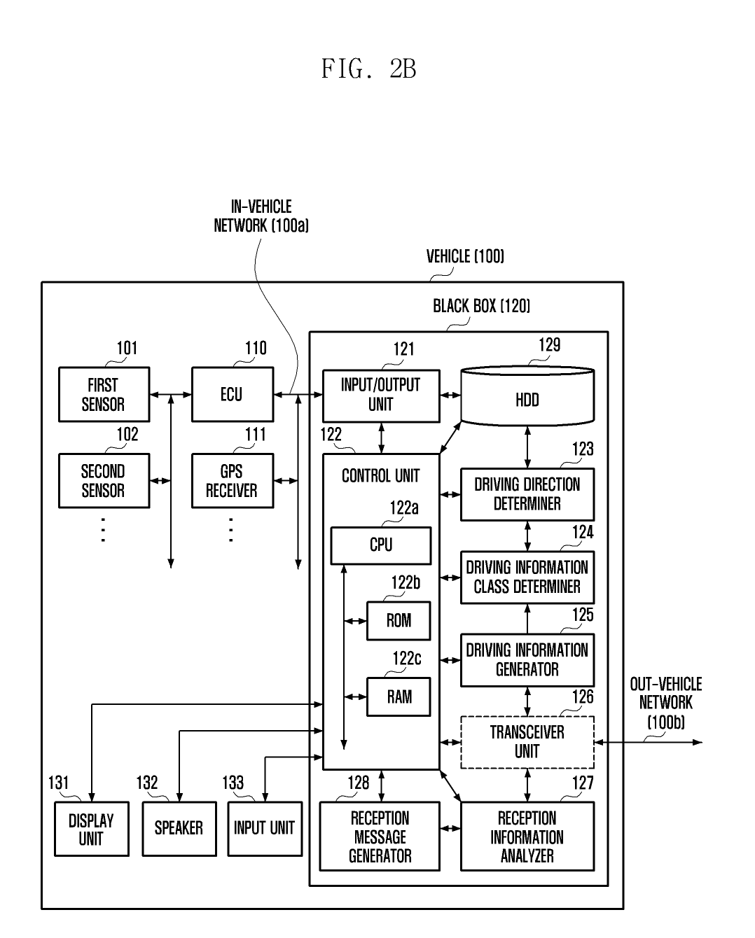

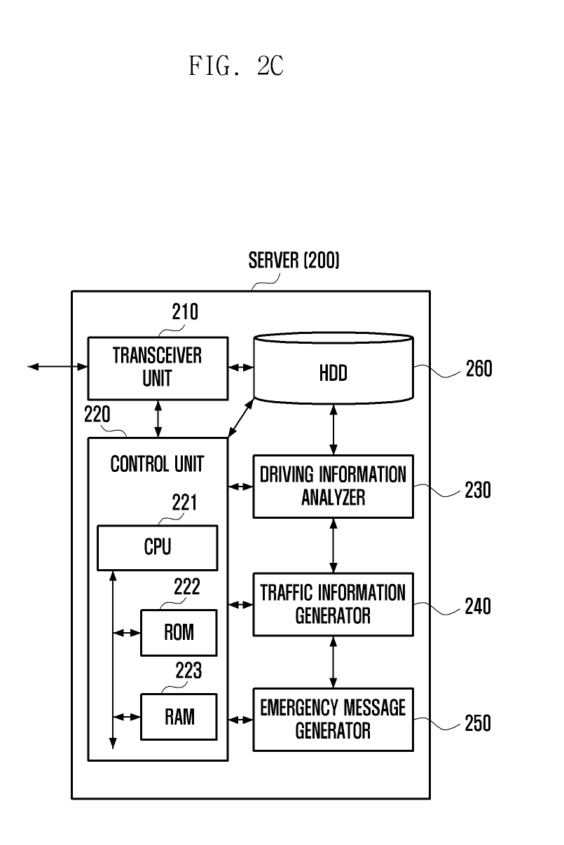

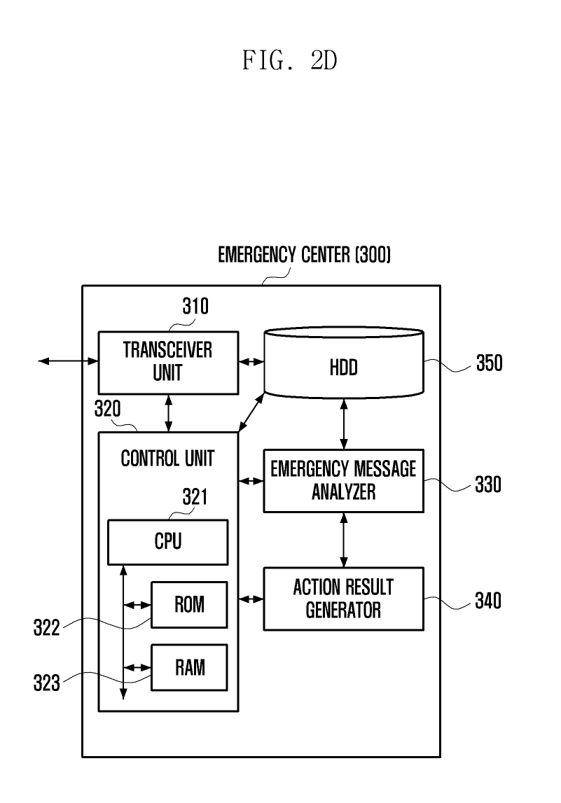

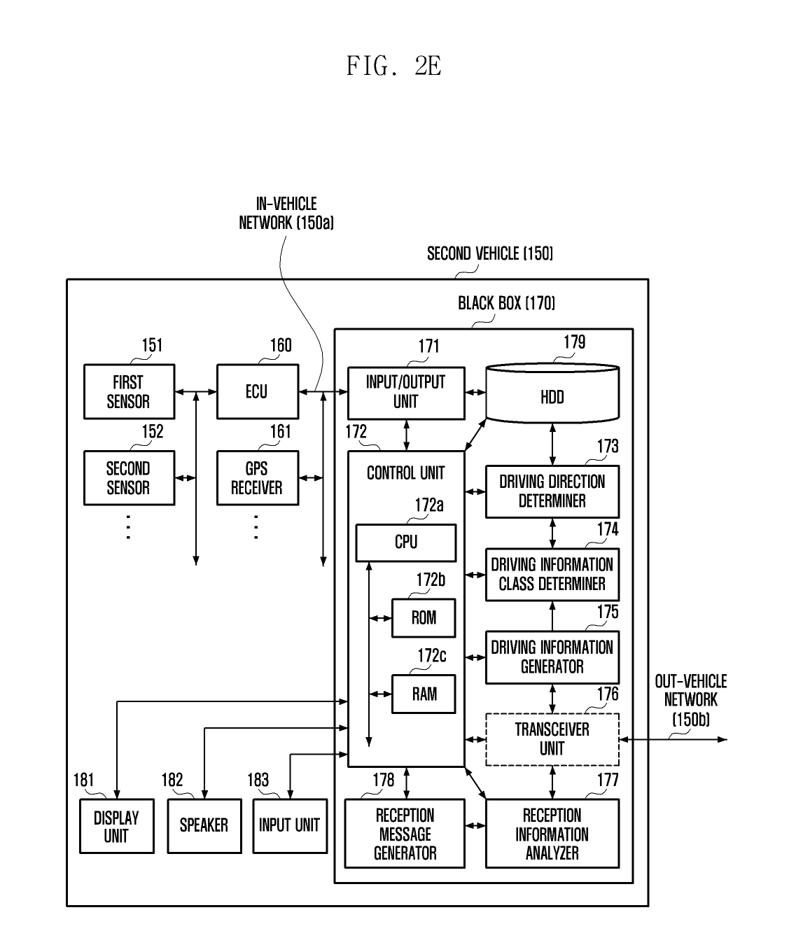

In addition, the vehicle 100 may include an Electronic Control Unit (ECU) 29 to receive a first signal from each sensor monitoring vehicle states, a black box 28 to receive a second signal corresponding to the first signal from the ECU 29, and an out-vehicle network 30 to wirelessly communicate with a server 200, an emergency center 300 and a second vehicle 150 (illustrated in FIG. 2A).

The sensors installed in the vehicle 100 of FIG. 1 are illustrative examples. One or more sensors may be added to or removed from the vehicle 100 according to performance and safety conditions.

FIGS. 2A to 2E are block diagrams of a vehicle, a server, an emergency center and a second vehicle according to an exemplary embodiment of the present invention.

Referring to FIG. 2A, the vehicle 100 may be connected to an out-vehicle network 100b. The vehicle 100 may be connected to the second vehicle 150, the server 200 or the emergency center 300 through the out-vehicle network 100b.

The vehicle 100 may be connected to the second vehicle 150 via the server 200 through the out-vehicle network 100b. Although not illustrated in FIG. 2A, the vehicle 100 may be connected to the second vehicle 150 using the out-vehicle network 100b.

The second vehicle 150 may be connected to the vehicle 100, the server 200 or the emergency center 300 through an out-vehicle network 150b.

The vehicle 100, the server 200, the emergency center 300 and the second vehicle 150 are described with reference to block diagrams of FIGS. 2B to 2E.

In the following description, the server 200, the emergency center 300 and the second vehicle 150 may be referred to as an “external equipment”.

FIG. 2B is a block diagram of a vehicle according to an exemplary embodiment of the present invention.

Referring to FIG. 2B, the vehicle 100 may include a first sensor 101, a second sensor 102, an ECU 110, a Global Positioning System (GPS) receiver 111, a black box 120, a display unit 131, a speaker 132, and an input unit 133.

When the vehicle 100 is driven or stopped/parked, at least one sensor such as the first sensor 101 or the second sensor 102 may transmit at least one first signal carrying a vehicle state to the ECU 110. That is, the ECU 110 may receive a first signal from the first sensor 101, the second sensor 102, or both the first sensor 101 and the second sensor 102. Here, vehicle states may indicate a state of the engine, a state of the brake system, current speed, and the like. Various sensors illustrated in FIG. 1 may transmit first signals to the ECU 110.

A first signal fed from one sensor to the ECU 110 may be an analog signal or a digital signal. Any sensor capable of sensing a vehicle state may be utilized.

The ECU 110 may receive a first signal carrying a vehicle state from each sensor such as the first sensor 101 or the second sensor 102. When the first signal is an analog signal, it may be converted into a digital signal using an A/D converter (not illustrated). When the first signal is a digital signal, A/D conversion is not needed.

When a first signal is received, the ECU 110 may identify the sensor having transmitted the first signal.

The ECU 110 may store a received signal as a digital signal and compare the signal with pre-stored vehicle conditions such as a driving speed, an engine state, a brake state, a fuel state, an accident, and a failure.

The ECU 110 may determine a vehicle state based on the comparison result. The ECU 110 may transmit a control signal corresponding to the comparison result to a component device (such as the engine or brake) associated with the sensor having transmitted a signal, thereby controlling the vehicle 100.

Vehicle conditions may be stored in a look-up table containing items related to vehicle states.

The ECU 110 may transmit a second signal (i.e., vehicle state information) corresponding to the received first signal to the black box 120 through an in-vehicle network 100a.

The second signal may carry a sensor identifier and sensor state (e.g., a normal state, an operation state or a failure state) of the sensor having transmitted the first signal. The transmission format of the second signal may be changed according to the transmission scheme between the ECU 110 and the black box 120. A second signal corresponds to a first signal, and a first signal may be used as a second signal in some cases.

The ECU 110 may transmit a second signal to the black box 120 in order of reception of the corresponding first signal.

The ECU 110 may pack several first signals (i.e., five first signals in order of reception) in one second signal, which is transmitted to the black box 120.

A second signal carrying vehicle state information may be an analog signal or a digital signal. The ECU 110 may transmit a second signal corresponding to a first signal from a sensor to the black box 120.

The black box 120 may receive a second signal and analyze the received second signal. The black box 120 may create driving information using the second signal and transmit the driving information to the server through an out-vehicle network 100b. Here, the driving information may include, for example, information regarding the driving direction, location and travel speed of the vehicle 100.

More than one ECU may be installed in the vehicle 100. For example, an engine ECU for managing the engine, an airbag ECU for managing airbags and a brake ECU for managing the brake system may be present.

Each ECU may transmit a second signal corresponding to a first signal to the black box 120 using the in-vehicle network 100a. An ECU may transmit a second signal to a main ECU (not illustrated) through the in-vehicle network 100a, and the main ECU may transmit a third signal corresponding to the second signal to the black box 120 through the in-vehicle network 100a.

The third signal may carry a sensor identifier and sensor state (e.g., a normal state, an operation state or a failure state) of the sensor having transmitted the corresponding first signal and an ECU identifier (e.g., an airbag ECU). The transmission format of the third signal may be changed according to the transmission scheme between the main ECU and the black box 120. The vehicle conditions preset in the ECU 110 may specify the class (e.g., an emergency or a non-emergency) of driving information generated by the black box 120.

The driving information of emergency class may be associated with a collision detection sensor, an airbag sensor, a fire detection sensor, a flat tire sensor and a fuel sensor.

When a first signal input to the ECU 110 has an emergency driving information class (i.e., in the event of a rear-ender), the ECU 110 may transmit a second signal corresponding to a rear-ender with an emergency driving information indicator to the black box 120.

The driving information class (e.g., an emergency or a non-emergency) may be determined by the ECU 110 or the black box 120. A separate user interface screen may be output on the display unit 131 to configure settings for the vehicle 100.

The in-vehicle network 100a may be built using wired communication based on a Controller Area Network (CAN) or using wireless communication based on Radio Frequency IDentification (RFID) or Bluetooth.

The in-vehicle network 100a may be used to transmit a second signal corresponding to a first signal input to the ECU 110 to the black box 120, although the present invention is not limited thereto.

The ECU 110 and the black box 120 may be configured as a single entity. In this case, the ECU 110 may be included in the black box 120.

When the ECU 110 and the black box 120 are configured as a single entity, they may be connected through an internal bus as opposed to being connected through the in-vehicle network 100a.

The GPS receiver 111 may compute the current location of the vehicle 100 based on Time Of Arrival (TOA) data of signals from multiple GPS satellites in medium Earth orbit.

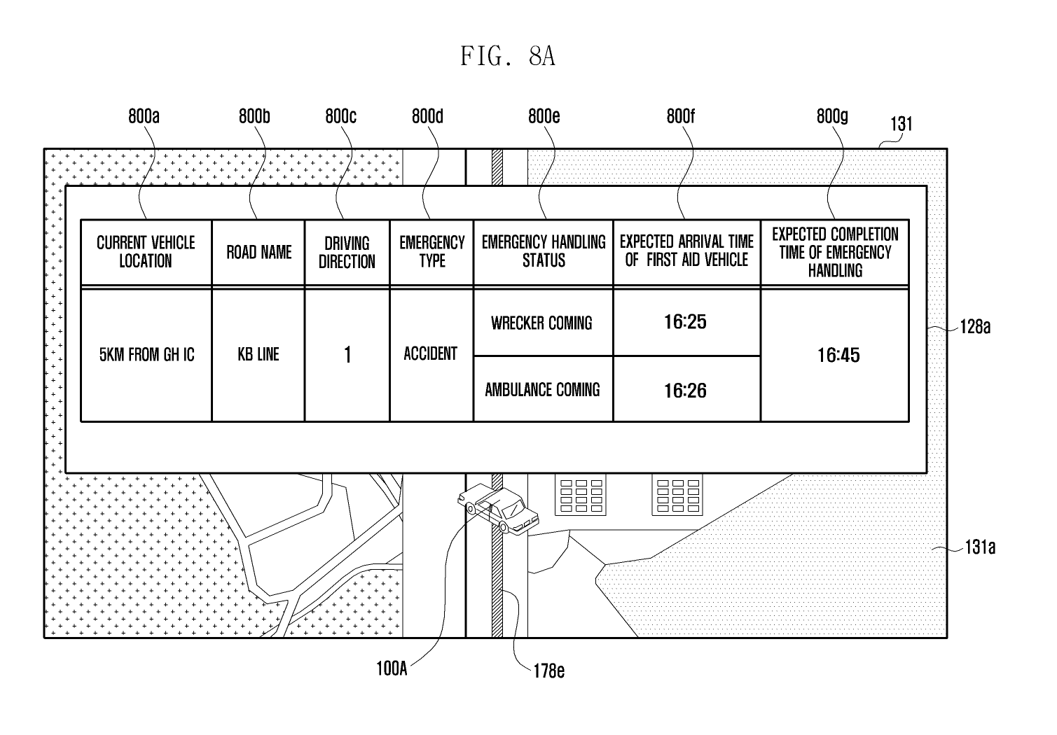

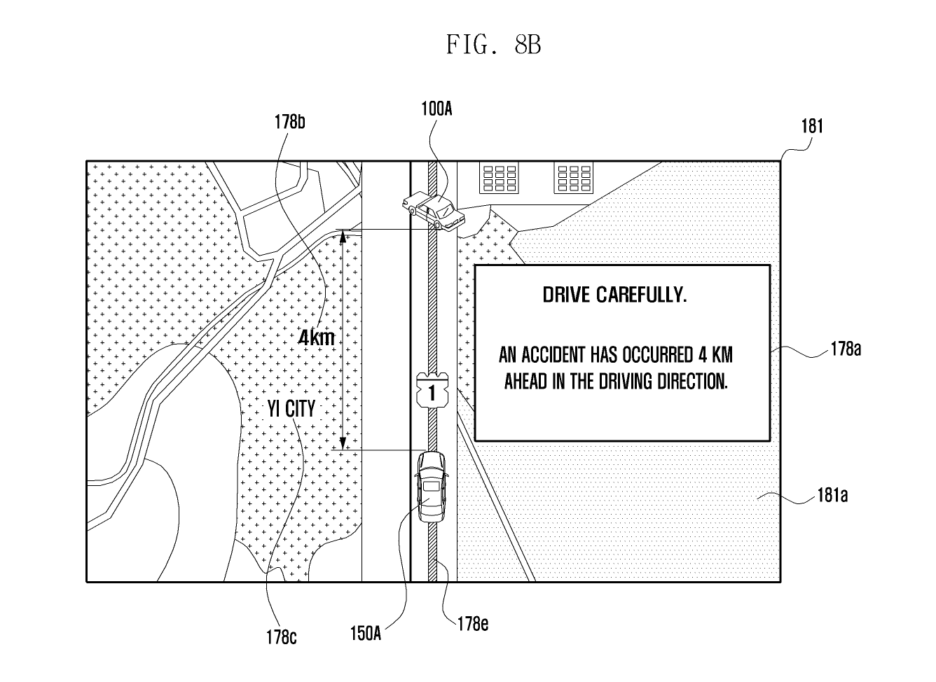

Computation of locations of the vehicle 100 using GPS satellites may produce an error. When map matching is performed on a digital map pre-stored in the GPS receiver 111 or the black box 120, an icon indicating the vehicle 100 may be presented in the road on a navigation map displayed on the display unit 131 (e.g., 100A in FIG. 8B).

The GPS receiver 111 may transmit the computed current location to the black box 120 through the in-vehicle network 100a.

The GPS receiver 111 may directly transmit location information received from GPS satellites to the black box 120. When the black box 120 performs map matching using the received location information on a pre-stored digital map, an icon 100A indicating the vehicle 100 may be presented in the road on a navigation map displayed on the display unit 131.

The current location of the vehicle 100 may be computed by the GPS receiver 111 or the black box 120, and one of the GPS receiver 111 and the black box 120 may be selected according to configuration settings of the vehicle 100.

In the following description, “location information” of the vehicle 100 or “vehicle location information” may indicate location information received from GPS satellites or a computed current location of the vehicle 100 using location information received from GPS satellites.

The black box 120 is a device for producing driving information or a reception message.

The black box 120 may include an input/output unit 121, a control unit 122, a driving direction determiner 123, a driving information class determiner 124, a driving information generator 125, a transceiver unit 126, a reception information analyzer 127, a reception message generator 128 and a Hard Disk Drive (HDD) 129.

A black box has originated from a flight recorder, which is placed in an aircraft to record navigation conditions such as speed, altitude and pilot voices for the purpose of facilitating investigation of aircraft accidents.

In an exemplary implementation, the black box 120 may include a digital tachograph to store and manage driving records over time, a vehicle event data recording system to collect information on vehicle operations and driver actions for reproducing an accident situation, and a digital video recorder to record driving situations as images for 10 to 30 seconds before and after an accident. That is, the black box 120 may include a digital tachograph, a vehicle event data recorder, and a digital video recorder.

The black box 120 may receive signals from various sensors and the ECU 110, and transmit stored vehicle state information to the second vehicle 150, the server 200 and the emergency center 300 through the transceiver unit 126 using wireless communication.

The black box 120 may receive various services and information on the vehicle 100 such as traffic information or emergency action results from the second vehicle 150, the server 200, the emergency center 300 and the like.

A device, which is capable of communicating with the ECU 110 through the in-vehicle network 100a and wirelessly communicating with an external equipment of the vehicle 100 through the out-vehicle network 100b, such as a mobile terminal, a smart phone, a tablet personal computer or a laptop computer may be used as the black box 120.

To function as the black box 120, the mobile terminal, the smart phone, the tablet computer or the laptop computer may install a separate application or updated firmware.

The black box 120 may be configured in various ways not described above as a device for producing driving information or a reception message. For example, the black box 120 may be a device for producing driving information or a reception message without storing vehicle state information.

The input/output unit 121 may input a second signal (i.e., vehicle state information) from the ECU 110 through the in-vehicle network 100a, and output a control signal corresponding to the second signal to the ECU 110 under control of the black box 120.

The input/output unit 121 may input a computed location of the vehicle 100 or location information of GPS satellites for computing a current location, from the GPS receiver 111.

The control unit 122 may include a Central Processing Unit (CPU) 122a, a Read Only Memory (ROM) 122b to store control programs for the vehicle 100 and the black box 120, and a Random Access Memory (RAM) 112c to store signals received through the input/output unit 121, store data for the black box 120 or be used as a working memory therefor. The CPU 122a, the ROM 122b and the RAM 112c may be interconnected through an internal bus.

The control unit 122 may control the input/output unit 121, driving direction determiner 123, driving information class determiner 124, driving information generator 125, transceiver unit 126, reception information analyzer 127, reception message generator 128 and the HDD 129.

The driving direction determiner 123 may determine the driving direction of the vehicle 100 during driving or in a stopped or parked state. The driving direction of the vehicle 100 may be determined using location information received from the GPS receiver 111.

When the vehicle 100 is driven, location information of the vehicle 100 input from the GPS receiver 111 may be stored in the storage of the black box 120 and updated at regular intervals (e.g., once per second).

The driving direction determiner 123 may determine the driving direction of the vehicle 100 using updated location information (path of the vehicle 100). The driving direction determiner 123 may also determine the driving direction using updated location information and a pre-stored digital map.

For example, assume that the vehicle 100 starts from YJ-IC to go to “SW” along “KB line”. When the vehicle 100 is near PG-IC, the path from YJ-IC to PG-IC may indicate that the vehicle 100 moves in a direction toward “BS”.

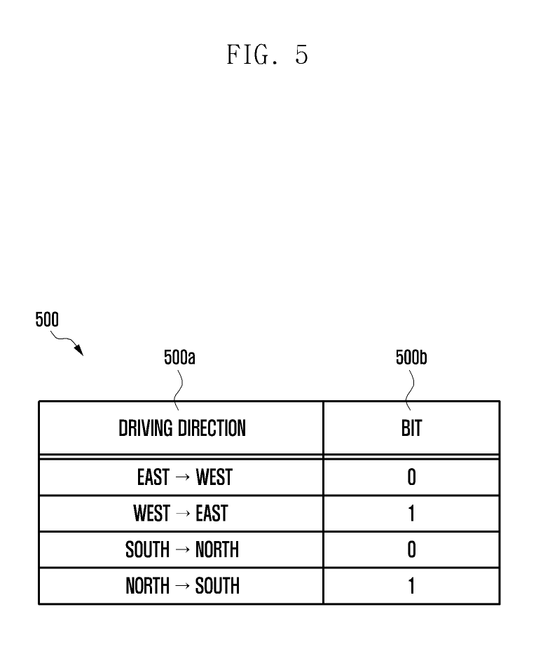

FIG. 5 illustrates a driving direction table according to an exemplary embodiment of the present invention.

Referring to FIG. 5, when the black box 120 transmits driving information to an external equipment through the out-vehicle network 100b, the driving information may contain a driving direction 500a described in the driving direction table 500.

The driving direction table 500 may contain fields for driving directions 500a and associated bits 500b.

For example, referring to FIG. 5, when the driving direction of the vehicle 100 is “east to west”, the bit is set to “0”. When the driving direction is “west to east”, the bit is set to “1”. When the driving direction is “south to north”, the bit is set to “0”. When the driving direction is “north to south”, the bit is set to “1”.

The format and fields of the driving direction table 500 may be changed (added to, deleted from or edited) according to settings.

The driving direction contained in driving information may be mapped to 1 bit or 1 byte according to settings for the driving direction table 500.

Driving directions may be applied to expressways and regular roads. The driving direction determiner 123 may determine the driving direction of the vehicle 100 in other fashions.

When the vehicle 100 is scheduled to enter a road having a central separator (like “KB” expressway) via a ramp, the driving direction determiner 123 may insert the driving direction in driving information immediately after entering the road. While the vehicle 100 is driven, the driving direction determiner 123 may continue to use the initially determined driving direction. The path of the vehicle 100 may be continuously updated.

When the vehicle 100 exits the road via a ramp, the driving direction determiner 123 may determine the driving direction using the updated path of the vehicle 100.

The above scheme for driving direction determination may also be applied to the server 200.

The driving information class determiner 124 may assign or determine the class of driving information. Driving information may contain a class indicator. The driving information class determiner 124 may determine the class of driving information based on a second signal stored in the storage.

Driving information classes may be pre-stored at the time of manufacture or may be received from the server 200, the emergency center 300 or the second vehicle 150.

Driving information classes may be of emergency or non-emergency. Driving information classes may be changed (e.g., added to, deleted from or edited) according to settings of the vehicle 100.

The driving information class determiner 124 may determine the class of driving information by comparing a sensor identifier and sensor state carried by a second signal from the ECU 110 with a pre-stored driving information class table (not illustrated).

For example, when a second signal input to the black box 120 corresponds to a first signal input to the ECU 110 from the front collision detection sensor 20, the driving information class determiner 124 may compare the second signal with the driving information class table and determine the class of driving information to be of emergency.

When a second signal from the ECU 110 is associated with the fire detection sensor 14, the tire pressure sensor 21 or the fuel sensor 29, the driving information class determiner 124 may determine the class of driving information to be of emergency.

Emergency driving information classes may be associated with various sensors installed in the vehicle 100 in addition to the sensors described above.

When the driving information class table specifies only sensors associated with emergency driving information, a second signal originated from a sensor not listed in the driving information class table may be determined to be non-emergency driving information.

The driving information generator 125 generates driving information (to be transmitted to the external equipment) containing a determined driving direction and driving information class.

The driving information may include a black box model name, a frame number, vehicle type (e.g., a bus, a taxi, a two-wheeled vehicle, a truck, and the like), a registration number, vehicle location, driving information class (e.g., an emergency or a non-emergency), emergency type (e.g., an accident or a failure), driving direction, driving speed, a contact address (e.g., a telephone number or an IP address) and an emergency occurrence time.

A format of driving information is illustrated in Table 1.

TABLE 1

| Fields | Length |
|---|---|
| Black box model name | 5 |
| Driving direction | 1 |
| Driving information class | 1 |
| Vehicle location | 10 |
| Emergency type | 3 |
| Emergency occurrence time | 5 |
| Contact address | 12 |

For example, referring to Table 1, the driving direction set to “0” indicates “east to west”, and the driving direction set to “1” indicates “west to east”. The driving information class set to “0” indicates non-emergency, and the driving information class set to “1” indicates emergency. The vehicle location indicates the location of the vehicle 100 computed using signals from GPS satellites. The emergency type set to “000” indicates non-emergency; the emergency type set to “001” indicates an accident; and the emergency type set to “010” indicates a failure. The emergency occurrence time indicates the time when an emergency occurred. The contact address may be a phone number or IP address of an external equipment wishing to receive driving information.

In Table 1, lengths of fields are not fixed and may be changed, and may be in units of bits or bytes.

The driving information generator 125 may generate driving information utilizing all or some data items provided by the vehicle 100.

A new data item may be added to driving information, and an existing data item thereof may be deleted or changed.

The driving information may be in an image format, a text format or a sound format.

Image format driving information may be a bitmap image or a vector graphic image. When an external equipment receives image format driving information, it may display the same on a display unit (not illustrated).

Text format driving information may have an extension like “txt” or “rtf”. When an external equipment receives text format driving information, it may display the same on a display unit (not illustrated).

Sound format warning information may have an extension like “way”, “voc”, “mid” or “mp3”. When an external equipment receives sound format warning information, it may reproduce the same through a speaker (not illustrated).

If necessary, image or text format driving information may contain metadata describing (i.e., descriptions and definitions) the driving information.

The format of the driving information may be changed according to settings of the vehicle 100. The black box 120 of the vehicle 100 may transmit a query for available driving information formats to an external equipment, and receive a corresponding response from the external equipment.

When a query response indicating a driving information format is received from the external equipment, the driving information generator 125 may generate driving information of the received format and transmit the generated driving information to the external equipment.

The transceiver unit 126 may transmit driving information generated by the driving information generator 125 to an external equipment through the out-vehicle network 100b.

The transceiver unit 126 may transmit driving information to at least one of the server 200, the emergency center 300 and the second vehicle 150 (e.g., to the server 200, to the emergency center 300, to the second vehicle 150, to the server 200 and the emergency center 300, to the server 200, the emergency center 300 and the second vehicle 150).

The driving information may be transmitted using a pre-stored contact address such as a phone number or an IP address of an external equipment. The pre-stored contact addresses of external equipments may be changed (e.g., added to, deleted from or edited).

The transceiver unit 126 may use the out-vehicle network 100b based on various communication schemes such as a Code Division Multiple Access (CDMA) scheme (3G), a Wideband Code Division Multiple Access (WCDMA) scheme (3.5G), a Long Term Evolution (LTE) scheme (4G), and a Worldwide Interoperability for Microwave Access (WiMax) or a Wireless Broadband (WiBro) scheme to transmit data, voices or images.

The transceiver unit 126 may support, for example, the WiBro scheme only, both the WCDMA and the WiMax scheme, or all of the CDMA scheme, the WCDMA scheme, the LTE scheme, the WiMax scheme and the WiBro scheme.

The transceiver unit 126 may use Very-High Frequency (VHF) waves or Ultra-High Frequency (UHF) waves for short range wireless communication as in the case of a walkie-talkie.

The CDMA scheme, the WCDMA scheme, the LTE scheme, the WiMax scheme, the WiBro scheme and the walkie-talkie style communication may be used according to the distance between the vehicle 100 and an external equipment.

In the following description, driving information used for the vehicle 100 and driving information used for the second vehicle 150 have corresponding meanings. Similarly, a reception message 128a (as illustrated in FIG. 8A) and a reception message 178a (as illustrated in FIG. 8B) have corresponding meanings.

The transceiver unit 126 may receive reception information (traffic information for non-emergency class driving information or action result for emergency class driving information) from an external equipment (i.e., a server 200 or an emergency center 300) through the out-vehicle network 100b.

In the non-emergency class driving information, traffic information related to the road on which the vehicle 100 is driven may be generated and transmitted to the vehicle 100 and/or other vehicles travelling on the road. Here, the driving information may contain information on the driving direction of the vehicle 100. The traffic information may contain location information of another vehicle having transmitted emergency class driving information and/or an emergency occurrence time.

In an exemplary implementation, the traffic information may contain the driving direction table 500 of the vehicle 100. Referring back to FIG. 5, the driving direction table 500 may contain fields for driving directions 500a and associated bits 500b. For example, when the driving direction of the vehicle 100 is “east to west”, the bit is set to “0”. When the driving direction is “west to east”, the bit is set to “1”. When the driving direction is “south to north”, the bit is set to “0”. When the driving direction is “north to south”, the bit is set to “1”.

The driving direction table 500 may be received from the server 200, or may be pre-stored in the storage of the black box 120 by the manufacturer.

Received reception information may be stored in the storage under control of the control unit 122.

The transceiver unit 126 may be included in the black box 120 or may be a separate entity from the black box 120.

When the transceiver unit 126 is a separate entity from the black box 120, it may communicate with the black box 120 through the in-vehicle network 100a, and may communicate with the ECU 110 through the in-vehicle network 100a.

A device that is capable of communicating with the black box 120 through the in-vehicle network 100a and wirelessly communicating with the external equipment, such as a mobile terminal, smartphone, tablet computer or laptop computer, may be used as the transceiver unit 126.

To act as the transceiver unit 126, a mobile terminal, a smartphone, a tablet personal computer or a laptop computer may install a separate application or updated firmware.

In the following description, the reception information analyzer 127 and the reception message generator 128 may correspond respectively to a reception information analyzer 177 and a reception message generator 178 of a second vehicle 150 having received warning information transmitted from the vehicle 100.

The reception information analyzer 127 may analyze reception information (i.e., traffic information or action result for the vehicle 100) received from the server 200.

The traffic information in the reception information may contain a road section, driving direction, speed, speed difference, congestion level, and contact address of the server 200 as items.

Items of the reception information may be used to generate a reception message 128a.

The reception information analyzer 127 may analyze all items of the traffic information or analyze high-priority items (such as a road section, congestion level or speed) thereof first.

The action result for the vehicle 100 in the reception information may contain a vehicle location, a road name, a driving direction, an emergency type, an emergency handling status, an expected arrival time of a first aid vehicle and an expected completion time of emergency handling as items.

Items of the action result for the vehicle 100 may be used to generate a reception message 128a.

The reception information analyzer 127 may analyze all items of the action result or analyze high-priority items (such as an emergency handling status and expected arrival time of a first aid vehicle) first.

The reception message generator 128 may generate a reception message 128a using the analysis results of reception information.

The reception message 128a may be in an image format, a text format or a sound format according to the reception information.

The reception message generator 128 may generate a reception message 128a in a manner conforming to the format of the reception information. For example, when the reception information is in a sound format, the reception message generator 128 may reproduce the reception information to the driver. Here, the reproduced reception information in a sound format becomes a reception message 128a.

The reception message generator 128 may generate a reception message 128a using all or some items among received driving information.

A generated reception message 128a may be delivered to the driver of the vehicle 100 in at least one of a visual form and a sound form.

When the reception message 128a is in a visual form (e.g., an image format or a text format), it may be delivered through the display unit 131. When the reception message 128a is in a sound form, it may be delivered through the speaker 132.

When the reception message 128a is in a visual and sound form, it may be delivered through both the display unit 131 and the speaker 132.

The HDD 129 may store a second signal from the ECU 110 and location information from the GPS receiver 111 under control of the control unit 122.

The HDD 129 may also store driving information to be transmitted through the transceiver unit 126, reception information (traffic information or action result) from the server 200 or the emergency center 300. The HDD 129 may also store a reception message 128a generated by the reception message generator 128, and contact information for the external equipment.

The HDD 129 may be included in the black box 120 or be separately installed in the vehicle 100.

In the description, “storage” may refer to the HDD 129, the ROM 122b or the RAM 122c in the control unit 122.

“Storage” may include a volatile memory, a nonvolatile memory, an HDD or a Solid State Drive SSD.

The display unit 131 may display various service screens related to, for example, a navigation map, Internet browsing and Digital Multimedia Broadcasting (DMB) reception. The display unit 131 may display a reception message 128a and a user interface screen 400 to receive driver settings corresponding to driving information.

When a navigation map (in FIG. 8A or in FIG. 8B) is displayed on the display unit 131, a reception message 128a may be displayed as a popup on the navigation map.

On a display unit 181 of the second vehicle 150, an icon 100A for the vehicle 100 and an icon 150A for the second vehicle 150 may be displayed in addition to a popup of a reception message 128a.

On the display unit 181, an icon 100A for the vehicle 100, an icon 150A for the second vehicle 150, and a distance between the vehicle 100 and the second vehicle 150 may be displayed in addition to a popup of a reception message 128a.

The speaker 132 produces various sounds related to, for example, music, a CD, and navigation and reception messages 128a.

The speaker 132 may produce sounds synthesized corresponding to a reception message 128a or a high-pitched sound like a collision sound to alert the driver.

The input unit 133 may generate an input signal corresponding to driver manipulation for selecting a service or setting a user interface screen 400 on the display unit 131. When the display unit 131 has a touchscreen capability, the input unit 133 and the display unit 131 may be a single entity.

The input unit 133 may include multiple buttons. For example, one or more buttons may be present in the steering wheel (not illustrated), and one or more buttons may be present in the center fascia (not illustrated).

FIG. 2C is a block diagram of a server according to an exemplary embodiment of the present invention.

Referring to FIG. 2C, the server 200 may include a transceiver unit 210, a control unit 220, a driving information analyzer 230, a traffic information generator 240, an emergency message generator 250, and an HDD 260.

The transceiver unit 210 may receive driving information from the vehicle 100, and transmit traffic information corresponding to the driving information to the vehicle 100 or the second vehicle 150.

The transceiver unit 210 may transmit an emergency message corresponding to the driving information to the emergency center 300. The transceiver unit 210 may receive an action result for the vehicle 100 from the emergency center 300 and transmit the action result to the vehicle 100.

The control unit 220 may include a CPU 221, a ROM 222 to store control programs for the server 200, and a RAM 223 that stores signals received through the transceiver unit 210 and stores data or is used as a working memory for the server 200. The CPU 221, the ROM 222 and the RAM 223 may be interconnected through an internal bus.

The control unit 220 may control the transceiver unit 210, the driving information analyzer 230, the traffic information generator 240, the emergency message generator 250 and the HDD 260.

The driving information analyzer 230 may analyze driving information received from the vehicle 100.

The received driving information may include a black box model name of the vehicle 100, a frame number, a vehicle type (e.g., a bus, a taxi, a two-wheeled vehicle, a truck, and the like), a registration number, a vehicle location, a driving class information (e.g., an emergency or a non-emergency), an emergency type (e.g., an accident or a failure), a driving direction, a driving speed, a contact address (e.g., a telephone number or an IP address) of the vehicle 100 and an emergency occurrence time.

Items of the driving information analyzed by the driving information analyzer 230 may be used to generate traffic information or an emergency message according to the driving information class.

The driving information analyzer 230 may examine the driving information to determine whether the driving information class is of emergency or non-emergency.

When the driving information class is of non-emergency, the traffic information generator 240 may generate traffic information using the analyzed driving information and update existing traffic information under control of the control unit 220.

When the driving information class is of emergency, the emergency message generator 250 may create an emergency message to be transmitted to the emergency center 300 using the analyzed driving information under control of the control unit 220. The emergency center 300 may provide an emergency service to the vehicle 100. The emergency message may contain at least one of the emergency type, location of the vehicle 100 and emergency occurrence time.

The driving information analyzer 230 may analyze driving information in a manner suited to the format thereof (e.g., an image, a text or sound).

The driving information analyzer 230 may identify the driving direction of the vehicle 100 when the vehicle 100 enters a road having a central separator (like “KB” express way) via a ramp based on driving information.

While the vehicle 100 is driven on the road, the driving information analyzer 230 may continue to use the initially determined driving direction. The path of the vehicle 100 may be continuously updated.

When the vehicle 100 exits the road via a ramp, the driving information analyzer 230 may determine the driving direction using the updated path of the vehicle 100.

When the driving information class is a non-emergency, the traffic information generator 240 may generate traffic information.

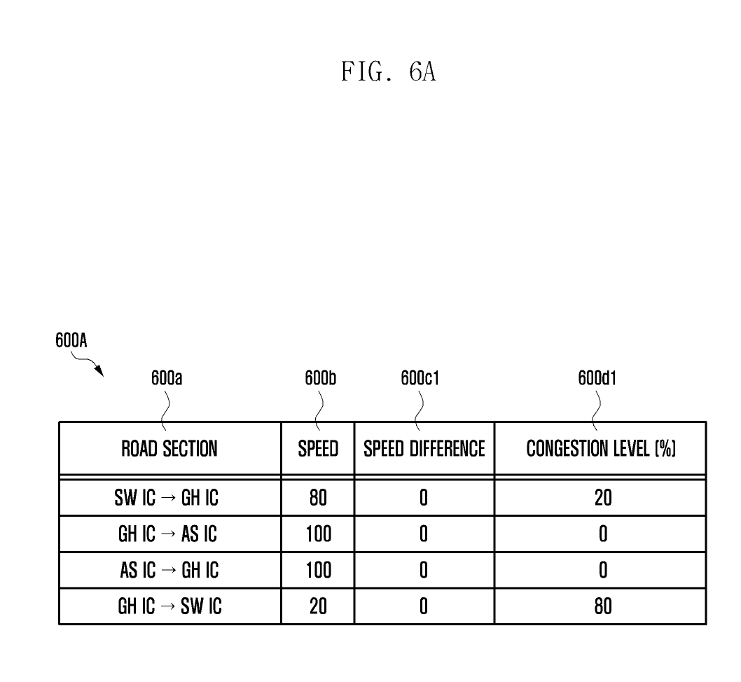

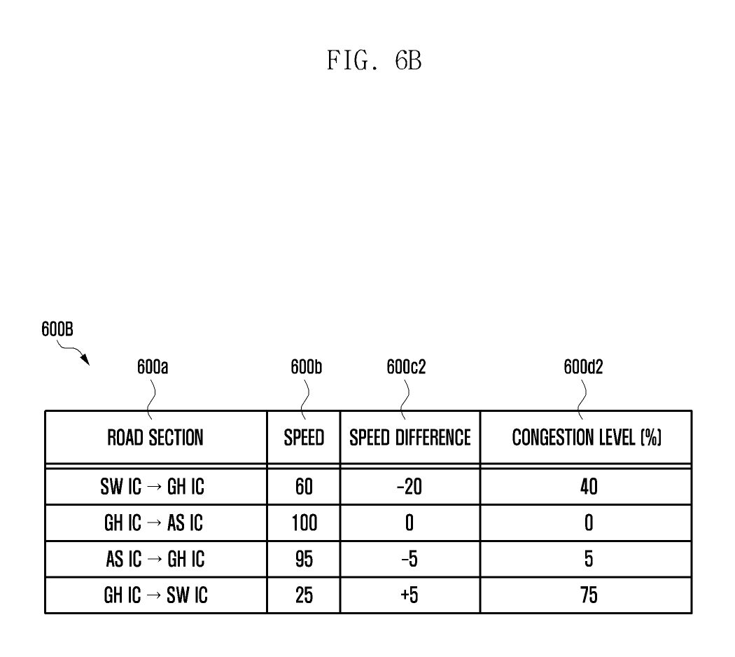

In FIG. 6A and 6B, a table 600A or a 600B of traffic information may contain fields for a road section 600a, speed 600b, speed difference 600c (i.e., 600c1 or 600c2), and congestion level 600d (i.e., 600d1 or 600d2).

The traffic information table 600A or 600B may include traffic information to be transmitted to the vehicle 100 when the corresponding driving information is non-emergency class driving information. The traffic information table 600A or 600B may further include traffic information to be transmitted to other vehicles travelling on the road section 600a.

The traffic information may be generated in an image format, text format or sound format according to the driving information.

The traffic information generator 240 may generate traffic information using all or some items of the received driving information.

The generated traffic information may be delivered to the drivers of the vehicle 100 and the second vehicle 150 in at least one of a visual form and a sound form.

The generated traffic information may contain the location of the vehicle 100 and emergency occurrence time when the corresponding driving information is emergency class driving information.

The traffic information (i.e., reception information) containing the location of the vehicle 100 and emergency occurrence time may be delivered to drivers of other vehicles including the second vehicle 150 in a visual form and/or a sound form.

Referring to FIG. 8A, an icon 100A representing the vehicle 100 having transmitted emergency class driving information is displayed on the display unit 131.

The generated traffic information may also contain the location and emergency occurrence time of the second vehicle 150 having transmitted emergency class driving information.

The traffic information (i.e., reception information) containing the location of the second vehicle 150 and emergency occurrence time may be delivered to drivers of other vehicles including the vehicle 100 in a visual form and/or a sound form.

When the driving information class is emergency class driving information, the emergency message generator 250 may create an emergency message to be transmitted to the emergency center 300 using the analyzed driving information under control of the control unit 220. The emergency message may be associated with the vehicle 100 having transmitted emergency class driving information.

The emergency message may contain an emergency type (e.g., an accident or a failure), a location of the vehicle 100, a contact address (e.g., a telephone number or an IP address) of the vehicle 100 and an emergency occurrence time.

The emergency message may be generated in an image format, text format or a sound format according to driving information.

The emergency message generator 250 may create an emergency message in at least one of an image format, a text format and a sound format according to a given emergency center 300. For example, when the emergency center 300 can receive only a sound format message, the emergency message may be created in a sound format.

A reception message 128a corresponding to emergency class driving information of the vehicle 100 is displayed.

The control unit 220 may transmit a generated emergency message to a given emergency center 300 through the transceiver unit 210.

Contact information (e.g., a telephone number or an IP address) of the emergency center 300 may be arranged according to the emergency type and stored in the storage.

The control unit 220 may select an emergency center 300 in consideration of the current location of the vehicle 100 having transmitted emergency class driving information.

For example, the control unit 220 may select an emergency center 300 near to the current location of the vehicle 100. When the emergency type is an accident (e.g., a car crash or a rear-ender), a police station, a hospital, a fire station or a wrecker may be selected as the emergency center 300. When the emergency type is a failure, a wrecker may be selected as the emergency center 300.

The HDD 260 may store driving information received from the vehicle 100, traffic information to be transmitted to the vehicle 100, an emergency message transmitted from the server 200 to the emergency center 300, and an action result for the vehicle 100 received from the emergency center 300.

The HDD 260 may also store contact information (e.g., a telephone number or an IP address) of the emergency center 300.

In the following description, “storage” may refer to the HDD 260, or the ROM 222 or the RAM 223 in the control unit 220.

“Storage” may include a volatile memory, a nonvolatile memory, an HDD or an SSD.

FIG. 2D is a block diagram of an emergency center according to an exemplary embodiment of the present invention.

Referring to FIG. 2D, the emergency center 300 may include a transceiver unit 310, a control unit 320, an emergency message analyzer 330, an action result generator 340, and an HDD 350.

The emergency center 300 may be a server, a computer or a call center associated with a police station, a hospital, a fire station or a wrecker. Any device or facility capable of receiving an emergency message from the server 200 and transmitting a corresponding action result to the server 200 may be used as the emergency center 300.

The transceiver unit 310 may receive an emergency message from the server 200 and transmit a corresponding action result for the vehicle 100 to the server 200.

The transceiver unit 310 may receive driving information directly from the vehicle 100.

The control unit 320 may include a CPU 321, a ROM 322 to store control programs for the emergency center 300, and a RAM 323 that stores signals received through the transceiver unit 310 and stores data or is used as a working memory for the emergency center 300. The CPU 321, the ROM 322 and the RAM 323 may be interconnected through an internal bus.

The control unit 320 may control the transceiver unit 310, the emergency message analyzer 330, the action result generator 340 and the HDD 350.

The emergency message analyzer 330 may analyze an emergency message received from the server 200.

The emergency message may include an emergency type (e.g., an accident or a failure), a location of the vehicle 100, a contact address (e.g., a telephone number or an IP address) of the vehicle 100 and an emergency occurrence time as items.

Items of the emergency message analyzed by the emergency message analyzer 330 may be used to generate an action result for the vehicle 100.

The emergency message analyzer 330 may analyze an emergency message in a manner conforming to the format thereof (e.g., an image, a text or a sound).

When the emergency center 300 receives driving information directly from the vehicle 100, the emergency message analyzer 330 may perform a function corresponding to that of the driving information analyzer 230 of the server 200. For example, items of analyzed driving information may be used to generate an action result for the vehicle 100.

When the emergency center 300 receives driving information directly from the vehicle 100, analysis for the vehicle 100 may be performed faster than in the case of receiving an emergency message via the server 200.

When the emergency center 300 receives driving information directly from the vehicle 100 and also receives an emergency message via the server 200, it may ignore the emergency message based on the earlier received driving information.

The action result generator 340 may generate an action result using all or some items of the analyzed driving information.

When multiple analyzed emergency messages indicate that locations of two or more vehicles are close to each other (e.g., within a radius of 30 meters), the emergency message analyzer 330 may determine that the two or more vehicles are involved in the same accident.

The action result generator 340 may generate an action result to be transmitted to the server 200 or generate an action result to be transmitted to the vehicle 100.

The action result generator 340 may generate an action result using all or some items of the analyzed emergency message.

When multiple emergency messages associated with nearby vehicles are received, the action result generator 340 may generate an action result table (not illustrated) for the nearby vehicles instead of generating multiple action results.

The control unit 320 may transmit the generated action result table to the multiple nearby vehicles through the transceiver unit 310.

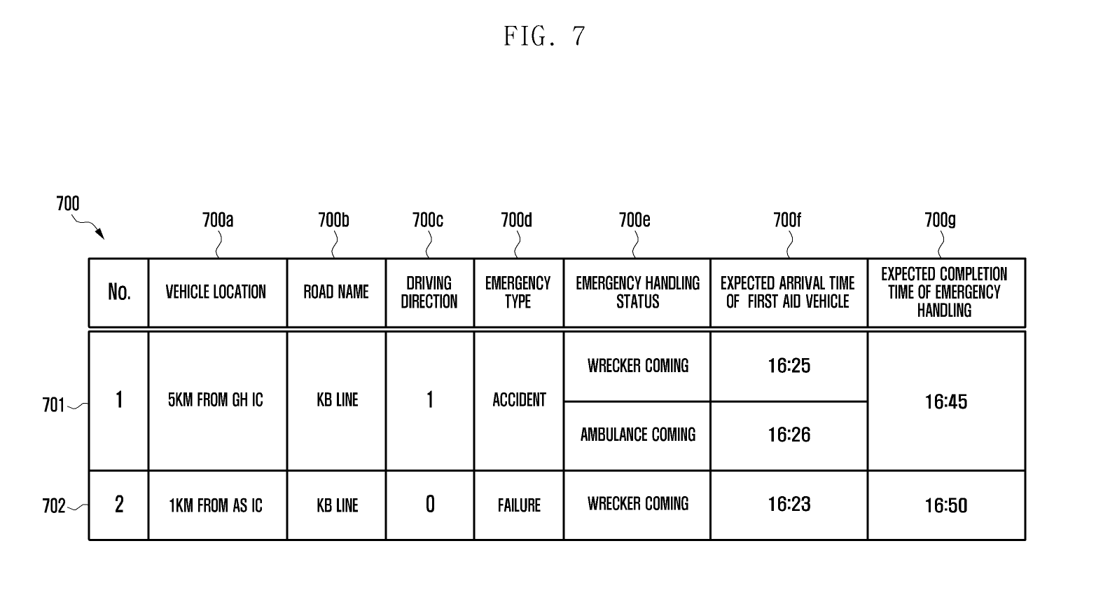

FIG. 7 illustrates status information regarding emergency actions generated by an emergency center according to an exemplary embodiment of the present invention.

Referring to FIG. 7, an action result table 700 may includes fields for a vehicle location 700a, a road name 700b, a driving direction 700c, an emergency type 700d, an emergency handling status 700e, an expected arrival time 700f of a first aid vehicle, and an expected completion time 700g of emergency handling.

In the action result table 700, entries may be listed in order of reception of emergency messages or driving information. For example, a first action result 701 is listed before a second action result 702 in the action result table 700.

In the action result table 700, entries may be sorted by emergency type (e.g., an accident or a failure). For example, the first action result 701 is listed before the second action result 702 because the emergency type of the first action result 701 is “accident” and that of the second action result 702 is “failure”.

In the action result table 700, an action result may be generated in an image format, a text format or a sound format according to a corresponding emergency message.

The action result generator 340 may generate an action result using all or some items of the analyzed emergency message.

The control unit 320 may transmit the generated action result to the server 200 through the transceiver unit 310. Upon reception of the action result, the server 200 may transmit the action result to the vehicle 100.

The control unit 320 may also transmit the generated action result directly to the vehicle 100 through the transceiver unit 310. Here, the control unit 320 may use the contact address (e.g., a telephone number or an IP address) of the vehicle 100 contained in the emergency message to transmit the action result.

The HDD 350 may store an emergency message received from the server 200 and driving information received from the vehicle 100. The HDD 350 may store an action result to be transmitted to the server 200 for the vehicle 100.

The HDD 350 may also store contact information (e.g., a telephone number or an IP address) of the server 200.

In the following description, “storage” may refer to the HDD 350, or the ROM 322 or the RAM 323 in the control unit 320.

“Storage” may include a volatile memory, a nonvolatile memory, an HDD or an SSD.

FIG. 2E is a block diagram of a second vehicle according to an exemplary embodiment of the present invention.

Referring to FIG. 2E, the second vehicle 150 may include a first sensor 151, a second sensor 152, an ECU 160, a GPS receiver 161, a black box 170, a display unit 181, a speaker 182, and an input unit 183.

The black box 170 may include an input/output unit 171, a control unit 172, a driving direction determiner 173, a driving information class determiner 174, a driving information generator 175, a transceiver unit 176, a reception information analyzer 177, a reception message generator 178 and an HDD 179. The control unit 172 may include a CPU 172a, a ROM 172b to store control programs for the second vehicle 150, and a RAM 172c that stores signals received through the transceiver unit 176 and stores data or is used as a working memory for the second vehicle 150.

The components 151 to 183 of the second vehicle 150 have similar functions and structures to the corresponding components 101 to 133 of the vehicle 100, and hence a detailed description thereof is omitted.

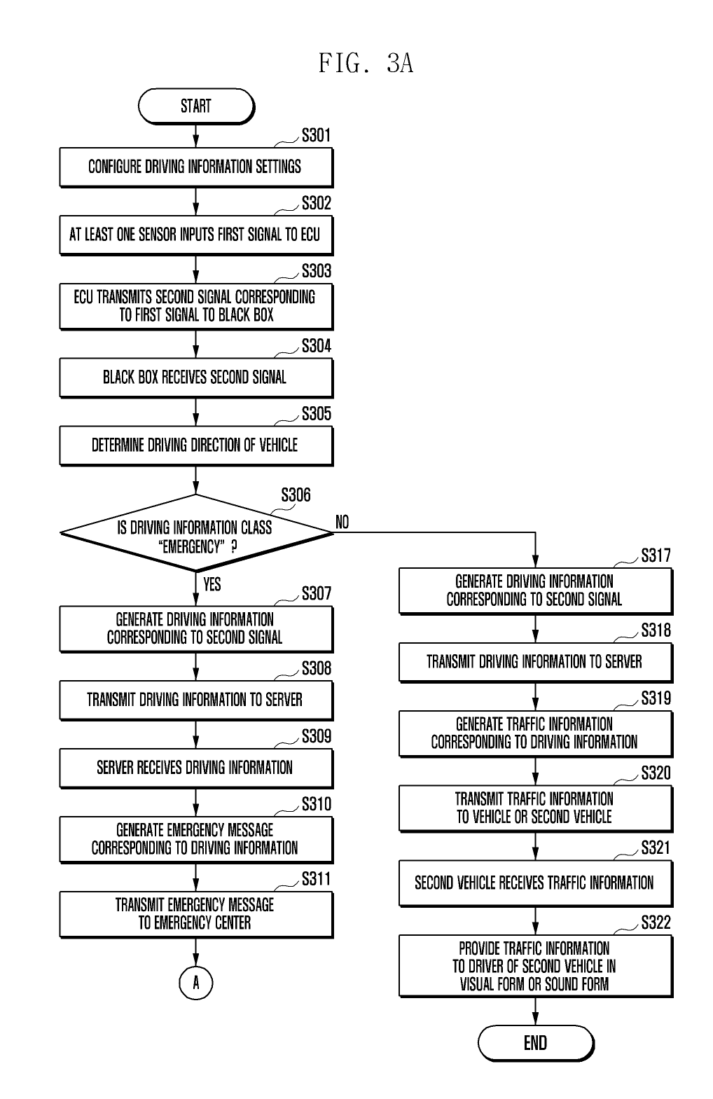

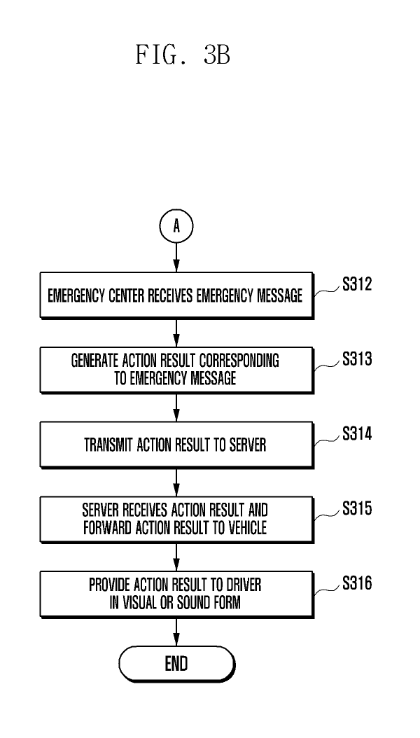

FIGS. 3A and 3B are flowcharts of information providing methods of a vehicle and a server according to an exemplary embodiment of the present invention.

Referring to FIG. 3A, the vehicle 100 receives driving information settings from the driver at step S301.

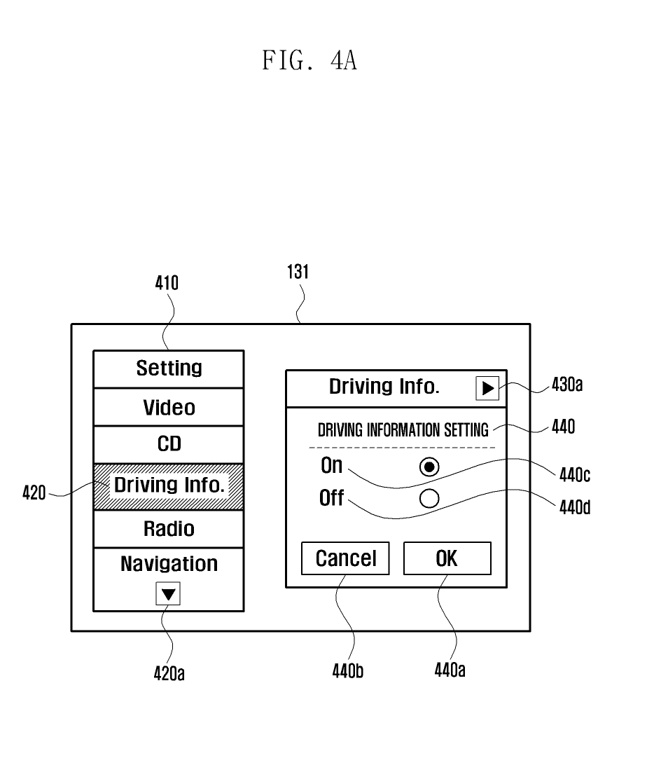

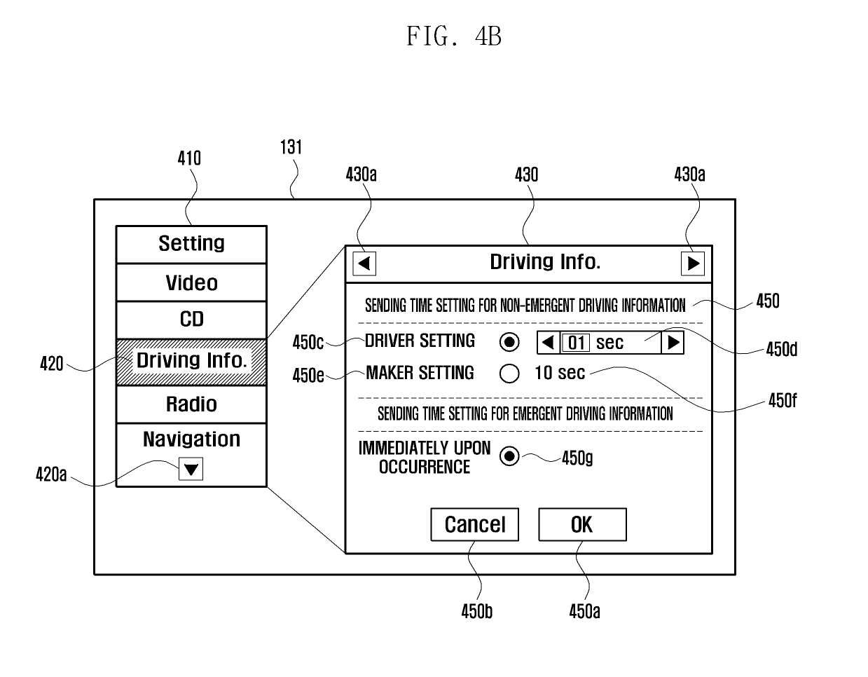

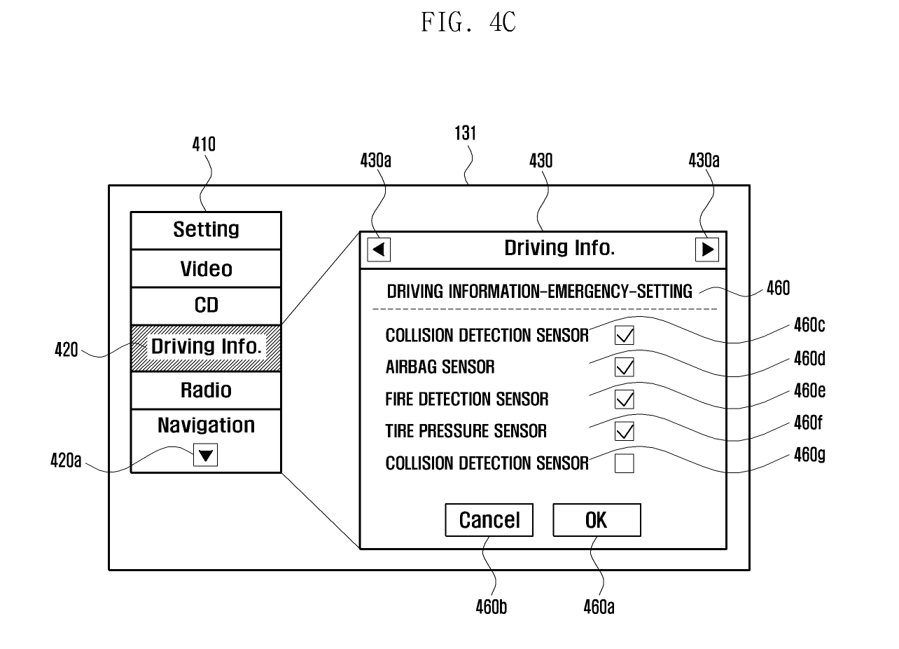

FIGS. 4A to 4C illustrate user interface screens for providing vehicle information according to an exemplary embodiment of the present invention.

Referring to FIG. 4A, a setting window 410 is displayed in a user interface screen on the display unit 131 of the vehicle 100.

The setting window 410 may include a “video” item, a “CD” item, a “driving information” item 420 and a “navigation” item. When a down direction key 420a is selected, additional items of the setting window 410 (i.e., subsequent items of the “navigation” item) may be displayed.

Items of the setting window 410 may be changed (e.g., added, deleted or edited) according to functions of the vehicle 100.

When the “driving information” item 420 is selected, a “driving information” window 430 containing a “driving information setting” item 440 is displayed near the selected item 420.

The “driving information setting” item 440 has an “on” option 440c to transmit driving information to an external equipment, and an “off” option 440d not to transmit driving information to an external equipment. In FIG. 4A, the “on” option 440c is selected.

When the driver selects an “OK” button 440a, driving information setting is confirmed. When the driver selects a “cancel” button 440b, driving information setting is aborted.

When a right direction key 430a of the “driving information” window 420 is selected, a “driving information transmitting time setting” item 450 (as illustrated in FIG. 4B) may be displayed.

Referring to FIG. 4B, the “driving information sending time setting” item 450 is used to set time intervals for transmitting emergency class driving information and non-emergency class driving information to the external equipment.

As to non-emergency class driving information, the time interval may be set by the driver using a “driver setting” option 450c or by the manufacturer using a “maker setting” option 450e.

For the “driver setting” option 450c, the time interval 450d may be set to 1 to 60 seconds; and the time interval 450d may be set in units of seconds, minutes, or hours. For the “maker setting” option 450e, the time interval 450f is preset to 10 seconds in FIG. 4B.

As to emergency class driving information, the time interval may be set by the manufacturer using an “immediately upon occurrence” option 450g.

The time interval 450d is set to 1 second using the “driver setting” option 450c for non-emergency class driving information.

When the driver selects an “OK” button 450a, “driving information transmitting time setting” is confirmed. When the driver selects a “cancel” button 450b, “driving information transmitting time setting” is aborted.

When the right direction key 430a of the “driving information” window 430 is selected, a “driving information-emergency-setting” item 460 (as illustrated in FIG. 4C) may be displayed.

Referring to FIG. 4C, the “driving information-emergency-setting” item 460 may be used to specify sensors associated with emergency class driving information based on second signals input from the ECU 110 to the black box 120. Such a sensor may also be specified based on a first signal input to the black box 120.

Sensors associated with emergency class driving information may include a collision detection sensor 460c, an airbag sensor 460d, a fire detection sensor 460e, a tire pressure sensor 460f and a fuel sensor 460g.

For example, when one of the collision detection sensor 460c, the airbag sensor 460d, the fire detection sensor 460e and the tire pressure sensor 460f inputs a first signal to the ECU 110 and the ECU 110 transmits a second signal corresponding to the first signal to the black box 120, the black box 120 may set the driving information class to “emergency”.

In another example, when one of the collision detection sensor 460c, the airbag sensor 460d, the fire detection sensor 460e and the tire pressure sensor 460f inputs a first signal to the black box 120, the black box 120 may set the driving information class to “emergency”.

The “driving information-emergency-setting” item 460 may have an “add” option (not illustrated). When the “add” option is selected, a list of sensors is displayed and the driver may select a sensor to be added to the item 460 from the list. The “driving information-emergency-setting” item 460 may have a “delete” option (not illustrated). By selecting the “delete” option, the driver may select a sensor to be deleted from the item 460.

For one or more sensors not specified by the “driving information-emergency-setting” item 460 in FIG. 4C, their driving information class may be treated as “non-emergency”.

When the driver selects an “OK” button 460a, “driving information-emergency-setting” is confirmed. When the driver selects a “cancel” button 460b, “driving information-emergency-setting” is aborted.

When the right direction key 430a of the “driving information” window 430 is selected, an additional item (not illustrated) for driving information setting may be displayed. When the left direction key 430a of the “driving information” window 430 is selected, the “driving information transmitting time setting” item 450 may be displayed.

Referring back to FIG. 3A, at least one sensor inputs a first signal to the ECU 110 at step S302.

For example, one of the sensors 10 to 27 in FIG. 1 or one of the first sensor 101 and second sensor 102 in FIG. 2 may transmit a first signal.

At step S302, in addition to the first sensor 101 and second sensor 102, any sensor capable of transmitting a first signal to the ECU 110 may be employed.

The ECU 110 transmits a second signal corresponding to the first signal to the black box 120 at step S303.

The ECU 110 may receive a first signal from a sensor and transmit a second signal (i.e., vehicle state information) corresponding to the first signal to the black box 120 through the in-vehicle network 100a.

The black box 120 receives the second signal from the ECU 110 at step S304.

The black box 120 may receive the second signal through the input/output unit 121. The received second signal may be stored in the storage under control of the control unit 122.

The black box 120 determines the driving direction of the vehicle 100 using the received second signal at step S305.

The driving direction of the vehicle 100 may be determined using location information of the vehicle 100 from the GPS receiver 111. The driving direction of the vehicle 100 may also be determined using traffic information received from the server 200.

When the vehicle 100 is driven, location information of the vehicle 100 input from the GPS receiver 111 may be stored in the storage of the black box 120 and updated at regular intervals.

The driving direction determiner 123 may determine the driving direction of the vehicle 100 using updated location information (i.e., the path of the vehicle 100) and a pre-stored digital map.

Referring to the driving direction table 500 in FIG. 5, the driving direction may be mapped to a bit or bit string. For example, when the driving direction of the vehicle 100 is “east to west”, the bit is set to “0”. When the driving direction is “west to east”, the bit is set to “1”. When the driving direction is “south to north”, the bit is set to “0”. When the driving direction is “north to south”, the bit is set to “1”.

The black box 120 determines whether the driving information class is “emergency” at step S306. When the driving information class is “emergency”, the black box 120 proceeds to step 307. When the driving information class is “non-emergency”, the black box 120 proceeds to step 317.

The black box 120 may determine the driving information class by determining whether the second signal is originated from a sensor classified as “emergency”.

For example, referring to FIG. 4C, when the second signal is originated from one of the collision detection sensor 460c, the airbag sensor 460d, the fire detection sensor 460e and the tire pressure sensor 460f, the driving information class may be determined to be “emergency”.

When the driving information class is “emergency”, the black box 120 generates driving information corresponding to the second signal at step S307.

The black box 120 may generate driving information, to be transmitted to an external equipment, containing the determined driving direction and driving information class (i.e., “emergency”).

The driving information may include a black box model name, a frame number, a vehicle type (e.g., a bus, a taxi, a two-wheeled, a truck), a registration number, a vehicle location, a driving class information (e.g., an emergency or a non-emergency), an emergency type (e.g., an accident or a failure), a driving direction, a driving speed, a contact address (e.g., a telephone number or an IP address) of the vehicle 100 and an emergency occurrence time.

The driving information may be generated utilizing all or some data items provided by the vehicle 100.

The format of driving information may be changed according to settings of the vehicle 100. The vehicle 100 may transmit a query as to available driving information formats to an external equipment, and receive a corresponding response from the external equipment. The vehicle 100 may generate driving information in a format identical to that of the received query response.

The black box 120 transmits the generated driving information to the server 200 at step S308.

The generated driving information may be transmitted to an external equipment such as the server 200, the emergency center 300 and the second vehicle 150 through the out-vehicle network 100b.

The out-vehicle network 100b may be based on various communication schemes such as a CDMA scheme (3G), a WCDMA scheme (3.5G), an LTE scheme (4G), and a WiMax scheme or a WiBro scheme to transmit driving information, data, voice or images.

The driving information may be transmitted using VHF waves or UHF waves for short range wireless communication as in the case of a walkie-talkie.

The CDMA scheme, the WCDMA scheme, the LTE scheme, the WiMax scheme, the WiBro scheme and the walkie-talkie style communication may be used according to the distance between the vehicle 100 and the external equipment.

The server 200 receives the driving information at step S309.

The server 200 may receive driving information from the vehicle 100 through the transceiver unit 210.

The received driving information may be stored in the storage (e.g., the HDD 260, or the ROM 222 or the RAM 223 in the control unit 220) under control of the control unit 220.

The server 200 generates an emergency message corresponding to the received driving information at step S310.

Under control of the control unit 220, the driving information may be analyzed and the emergency message (to be transmitted to the emergency center 300) may be generated using the analysis results.

The emergency message may contain the emergency type (e.g., an accident or a failure), a location of the vehicle 100, a contact address (e.g., a telephone number or an IP address) of the vehicle 100 and an emergency occurrence time.

The emergency message may be generated in an image format, a text format or a sound format according to the driving information.

The emergency message may be created in an image format, a text format or a sound format according to a given emergency center 300. For example, when the emergency center 300 can receive only a sound format message, the emergency message may be created in the sound format.

The server 200 transmits the generated emergency message to the emergency center 300 at step S311.

The control unit 220 may transmit a generated emergency message to a given emergency center 300 (determined according to the emergency type) through the transceiver unit 210.

The emergency center 300 may be selected in consideration of the current location of the vehicle 100 having transmitted emergency class driving information and the emergency type.

For example, an emergency center 300 near to the current location of the vehicle 100 may be selected. When the emergency type is an accident (e.g., a car crash or a rear-ender), a police station, a hospital, a fire station or a wrecker may be selected as the emergency center 300. When the emergency type is a failure, a wrecker may be selected as the emergency center 300.

Referring to FIG. 3B, the emergency center 300 receives the emergency message from the server 200 at step S312.

The emergency center 300 may receive an emergency message from the server 200 through the transceiver unit 310.

The emergency center 300 may receive driving information directly from the vehicle 100 (not via the server 200).

The received emergency message may be stored in the storage (the HDD 350, or the ROM 322 or the RAM 323 in the control unit 320) under control of the control unit 320.

The emergency center 300 generates an action result corresponding to the received emergency message at step S313.

The received emergency message may include an emergency type (e.g., an accident or a failure), a vehicle location of the vehicle 100, and an emergency occurrence time as items.

Under control of the control unit 320, the received emergency message may be analyzed and an action result for the vehicle 100 may be generated using the analysis results.

Driving information may include a black box model name, a frame number, a vehicle type (e.g., a bus, a taxi, a two-wheeled vehicle, a truck, and the like), a registration number, a vehicle location, a driving information class (e.g., an emergency or a non-emergency), an emergency type (e.g., an accident or a failure), a driving direction, a driving speed, a contact address (e.g., a telephone number or an IP address) of the vehicle 100 and an emergency occurrence time.

Under control of the control unit 320, received driving information may be analyzed and an action result for the vehicle 100 may be generated using the analysis results.

When driving information is received directly from the vehicle 100, the emergency center 300 may also perform a function identical to that of the driving information analyzer 230 of the server 200.

The generated action result may be stored in an action result table 700 of the storage.

When multiple analyzed emergency messages indicate that locations of two or more vehicles are close to each other (e.g., within a radius of 30 meters), the emergency center 300 may determine that the two or more vehicles are involved in the same accident.

When multiple vehicles are involved in the same accident, the emergency center 300 may dispatch multiple first aid vehicles to the site of the accident.

An action result table 700 created by the emergency center 300 is illustrated in FIG. 7.

Referring to FIG. 7, the action result table 700 may include fields for the vehicle location 700a, the road name 700b, the driving direction 700c, the emergency type 700d, the emergency handling status 700e, the expected arrival time 700f of a first aid vehicle, and the expected completion time 700g of emergency handling.

The action result table 700 may contain the first action result 701 and the second action result 702 corresponding to emergency messages received from separate vehicles.

In the action result table 700, entries may be listed in order of reception of emergency messages or driving information. For example, the first action result 701 is listed before the second action result 702 in the action result table 700.

In the action result table 700, entries may be sorted by emergency type (e.g., an accident or a failure). For example, the first action result 701 is listed before the second action result 702 because the emergency type of the first action result 701 is “accident” and that of the second action result 702 is “failure”.

At least one first aid vehicle may be dispatched according to the emergency type. For example, as to the first action result 701 having an emergency type 700d of “accident” and emergency handling statuses 700e of “wrecker approaching” and “ambulance approaching”, a wrecker and an ambulance are first aid vehicles. As to the action result 702 having an emergency type 700d of “failure” and an emergency handling status 700e of “wrecker approaching”, a wrecker is a first aid vehicle.

In the action result table 700, the expected arrival time 700f of a first aid vehicle and the expected completion time 700g of emergency handling may be determined in consideration of the congestion level of the road and driving speed of the first aid vehicle.

In the following description, an action result may have the same meaning as the action result 701.

The emergency center 300 transmits the generated action result to the server 200 at step S314.

The emergency center 300 may transmit the generated action result to the server 200 through the transceiver unit 310.

The emergency center 300 may transmit the action result 702 to a server having transmitted a corresponding emergency message.

The emergency center 300 may transmit the action result directly to the vehicle 100 having transmitted corresponding driving information (not via the server 200).

The server 200 receives the action result and forwards the action result to the vehicle 100 at step S315.

The server 200 may receive an action result for the vehicle 100 under an emergency situation. The server 200 may transmit the received action result to the vehicle 100 having transmitted driving information corresponding to the action result. The action result may contain an expected arrival time 700f of a first aid vehicle for the vehicle 100.

The received action result may correspond to the action result 701 of the action result table 700 in FIG. 7.

The received action result may be stored in the storage.

The black box 120 of the vehicle 100 provides the received action result to the driver in a visual form or a sound form at step S316.

The black box 120 may analyze the action result (i.e., the reception information) received from the server 200 and generate a reception message 128a using the analysis results.

The generated reception message 128a may be delivered to the driver of the vehicle 100 in at least one of a visual form (i.e., the display unit 131) and a sound form (i.e., the speaker 132).

The black box 120 may verify operability of the display unit 131 and the speaker 132.

When the speaker 132 is inoperable, the black box 120 may deliver the reception message 128a through the display unit 131 alone. When the display unit 131 is inoperable, the black box 120 may deliver the reception message 128a through the speaker 132 alone.

When both the display unit 131 and the speaker 132 are inoperable, the black box 120 may find a device capable of being connected through wireless communication based on Bluetooth or RFID, such as a mobile terminal, smartphone, tablet computer or laptop computer.

When such a device is found, the black box 120 may transmit the reception message 128a to the device, which then may deliver the reception message 128a to the driver in a visual form or a sound form.

In this case, the black box 120 may change the format of the reception message 128a so that the found device may successfully receive the reception message 128a.

FIG. 8A illustrates a reception message delivered to the driver of a vehicle according to an exemplary embodiment of the present invention.

Referring to FIG. 8A, the reception message 128a being displayed may contain fields for vehicle location 800a, road name 800b, driving direction 800c, emergency type 800d, emergency handling status 800e, expected arrival time 800f of a first aid vehicle, and expected completion time 800g of emergency handling.

An icon 100A representing the vehicle 100 and a congestion level 178e are indicated on a navigation map 131a displayed on the display unit 131.

The reception message 128a may be presented as a popup on the navigation map 131a displayed on the display unit 131.

The reception message 128a and the navigation map 131a may overlap on the display unit 131. Transparency of 0 to 100 percent may be assigned to the reception message 128a being overlapped.

The reception message 128a may be displayed for a preset time (e.g., for five seconds or until arrival of a first aid vehicle) on the display unit 131.

The size and position of the reception message 128a being displayed may be changed according to settings for user interface screens on the display unit 131.

The congestion level 178e may be presented in color or grayscale according to a value thereof (e.g., 0 to 100 percent). Colors or grayscale may be changed according to settings of the vehicle 100.

As to emergency class driving information, the information provision process ends after step S316 of delivering a reception message 128a to the driver.

Referring back to FIG. 3A, when the driving information class is “non-emergency”, the black box 120 generates driving information corresponding to the second signal at step S317.

The black box 120 may generate driving information, to be transmitted to an external equipment, containing the determined driving direction and driving information class (i.e., “non-emergency”).

The generated driving information may include a black box model name of the vehicle 100, a frame number, a vehicle type (e.g., a bus, a taxi, a two-wheeled vehicle, a truck, and the like), a registration number, a vehicle location, a driving information class (i.e., non-emergency), an emergency type (“000”), a driving direction, a contact address of the vehicle 100, and a driving speed.

Here, the contact address of the vehicle 100 may be excluded from the generated driving information.

The driving information may be generated utilizing all or some data items provided by the vehicle 100.

The format of driving information may be changed according to settings of the vehicle 100. The vehicle 100 may transmit a query for available driving information formats to an external equipment, and receive a corresponding response from the external equipment. The vehicle 100 may generate driving information in a format identical to that of the received query response.

The black box 120 transmits the generated driving information to the server 200 at step S318.

The generated driving information may be transmitted to an external equipment such as the server 200, the emergency center 300 and the second vehicle 150 through the out-vehicle network 100b.

The out-vehicle network 100b may be based on various communication schemes such as a CDMA scheme (3G), a WCDMA scheme (3.5G), a LTE scheme (4G), and a WiMax scheme or a WiBro scheme to transmit driving information, data, voice or images.

Driving information may be transmitted using VHF waves or UHF waves for short range wireless communication as in the case of a walkie-talkie.

The CDMA scheme, the WCDMA scheme, the LTE scheme, the WiMax scheme, the WiBro scheme or the walkie-talkie style communication may be used according to the distance between the vehicle 100 and the external equipment.

The server 200 generates traffic information corresponding to the received driving information at step S319.

The server 200 may receive driving information from the vehicle 100 through the transceiver unit 210.

Under control of the control unit 220, the driving information may be analyzed and the traffic information may be generated using the analysis results.

In the following description, the driving information may include a traffic information table 600.

FIGS. 6A and 6B illustrate traffic information tables created and updated by a server according to an exemplary embodiment of the present invention.

Referring to FIG. 6A, a traffic information table 600A may contain fields for a road section 600a, a speed 600b, a speed difference 600c1, and a congestion level 600d1.

Items of the traffic information table 600A may be displayed in a text form or an image form (e.g., color or grayscale).

The traffic information table 600A in FIG. 6A is the traffic information table 600 at time t, and the traffic information table 600B in FIG. 6B is the traffic information table 600 at time t+1.

In the table 600A, the road section 600a indicates a road section in which vehicles are driving, the speed 600b indicates the average speed of vehicles driving in the road section 600a, and the speed difference 600c is zero for the initial traffic information table.

The congestion level 600d indicates traffic congestion in a given road section and may be obtained by comparing driving speeds of vehicles in the road section with a reference speed (e.g., 100 km/hour) of the road section.

As to the traffic information table 600A, when an accident occurs in the road section 600a, values of the speed 600b and the congestion level 600d1 may be changed.

The traffic information table 600B in FIG. 6B is an updated version of the traffic information table 600A.

Referring to FIG. 6B, values in the speed 600b, the speed difference 600c2 and the congestion level 600d2 are changed for three load sections except for “GH IC to AS IC” road section.

This indicates that speed differences are present for the three road sections except for “GH IC to AS IC” road section and congestion levels are changed accordingly.

The traffic information table 600B may be updated at regular intervals or updated irregularly in response to reception of driving information. For example, when an accident occurs in a road section 600a, the traffic information table 600B may be updated (irregularly) immediately after occurrence of the accident.

The traffic information table may contain not only traffic information but also “emergency” class driving information.

For example, the traffic information table may be generated to contain traffic information and emergency messages (i.e., an emergency type—accident, vehicle location and emergency occurrence time).

Traffic information regarding a road section in the traffic information table may be transmitted to multiple vehicles including the vehicle 100 and second vehicle 150 travelling in the road section.

Referring to FIG. 8B, thanks to traffic information transmitted to the second vehicle 150, the driver of the second vehicle 150 may be aware of occurrence of an accident involving the vehicle 100.

The server 200 transmits the generated traffic information to the vehicle 100 and second vehicle 150 at step S320.

The server 200 may transmit traffic information through the transceiver unit 210 to the vehicle 100 or the second vehicle 150.

The second vehicle 150 receives the traffic information from the server 200 at step S321.

In the second vehicle 150, the received traffic information may be stored in the storage (e.g., the HDD 179, or the ROM 172b or the RAM 172c in the control unit 172) under control of the control unit 172.

The black box 170 of the second vehicle 150 provides the received traffic information to the driver in a visual form or a sound form at step S322.

The black box 170 may analyze the traffic information received from the server 200 and generate a reception message 178a using the analysis results.

The generated reception message 178a may be delivered to the driver of the second vehicle 150 in at least one of a visual form (i.e., the display unit 181) and a sound form (i.e., the speaker 182).

FIG. 8B illustrates a reception message 178a delivered to the driver of the second vehicle according to an exemplary embodiment of the present invention.

Referring to FIG. 8B, a region name 178c, an icon 100A representing the vehicle 100, an icon 150A representing the second vehicle 150, a reception message 178a and a distance 178b between the vehicle 100 and second vehicle 150 are displayed on a navigation map 181 a displayed on the display unit 181.

Positions of the icon 100A and icon 150A, on the navigation map 181a, corresponding to the distance 178b between the vehicle 100 and second vehicle 150 may be determined using the traffic information received from the server 200 and location information received from the GPS receiver 161.

The distance 178b between the vehicle 100 and second vehicle 150 may be contained in a reception message 178a. When the distance 178b between the vehicle 100 and second vehicle 150 is not contained in a reception message 178a, an alert phrase like “Drive carefully. An accident has occurred ahead in the driving direction.” may be displayed.

The reception message 178a may be presented as a popup on the navigation map 181a. The reception message 178a and the navigation map 181a may overlap on the display unit 181, and a transparency of 0 to 100 percent may be assigned to the reception message 178a being overlapped.

The reception message 178a may be displayed for a preset time (e.g., for five seconds or until arrival at the vehicle 100) on the display unit 181.

The size and position of the reception message 128a being displayed may be changed according to settings for user interface screens on the display unit 181.

The congestion level 178e may be presented in color or grayscale according to the value thereof (e.g., 0 to 100 percent). Colors or grayscale may be changed according to settings of the second vehicle 150.

As to non-emergency class driving information, the information provision process ends after step S322 of delivering a reception message 178a to the driver of the second vehicle 150.

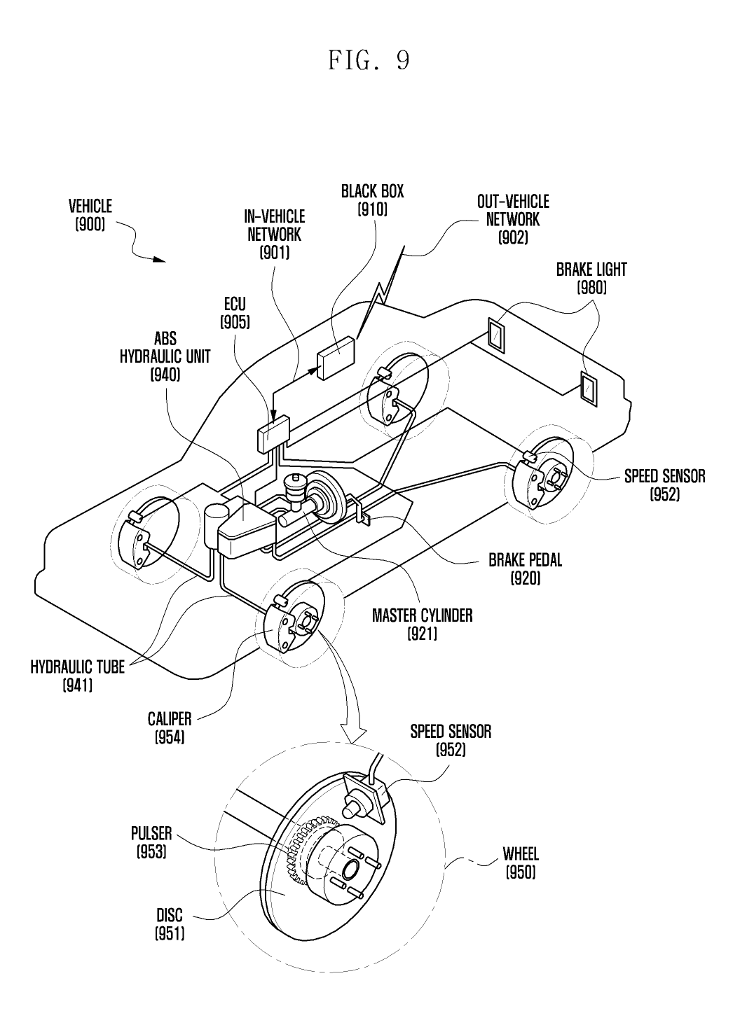

FIG. 9 illustrates a brake system of a vehicle according to an exemplary embodiment of the present invention.

Referring to FIG. 9, when the driver of the vehicle 900 steps on a brake pedal 920, a master cylinder 921 applies hydraulic pressure to stop the wheels 950.

An Anti-lock Brake System (ABS) hydraulic unit 940 installed between the master cylinder 921 and the wheels 950 may adjust hydraulic pressure applied to the wheels 950 to regulate the brake force.

Although a single wheel 950 is illustrated in FIG. 9, the “wheel” 950 may refer to a single wheel or multiple wheels installed on the vehicle 900 in the following description.

A disc brake or a drum brake may be installed on the wheel 950. In FIG. 9, it is assumed that disc brakes are installed on the front and rear wheels.

When the brake pedal 920 is stepped on, hydraulic pressure is transferred through a hydraulic tube 941 to the wheel 950. By the hydraulic pressure, the pad of a caliper 954 is pushed against a disc 951 of the wheel 950, generating brake force. At this time, a brake light 980 is turned on.

In an ABS, an ECU 905 controls the caliper 954 to repeatedly push against and release the rotating disc 951 (e.g., a pumping operation), preventing the wheel 950 from locking up (e.g., sliding due to inertia without rotation).

A speed sensor 952 may monitor rotation of a pulser 953 (e.g., a toothed ring or a tone ring) rotating with the disc 951 of the wheel 950, and transmit, for example, an analog voltage signal corresponding to the monitored rotation to the ECU 905.

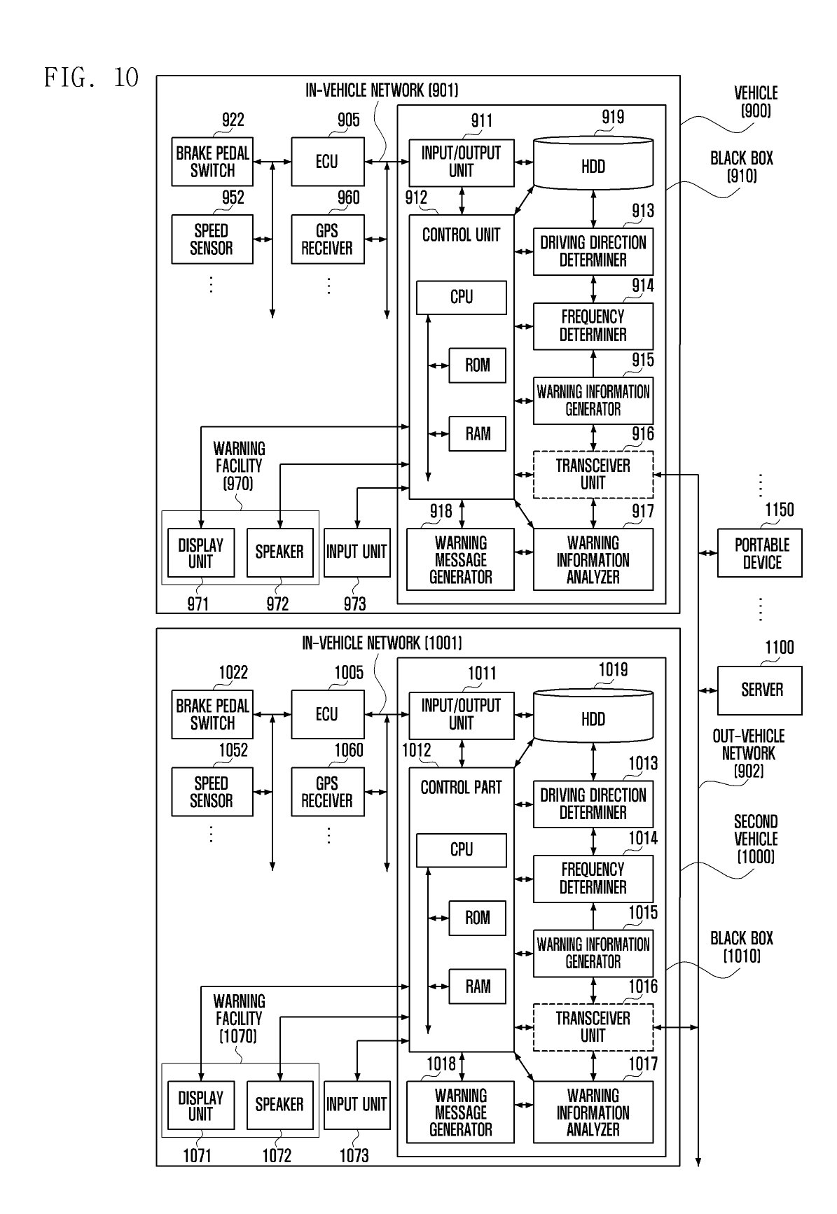

A brake pedal switch 922 (as illustrated in FIG. 10) may monitor brake pedal pressure applied by the brake pedal 920 stepped on by the driver, and transmit, for example, a voltage signal corresponding to the applied brake pedal pressure to the ECU 905.

A first signal input from the speed sensor 952 or brake pedal switch 922 to the ECU 905 may be converted into a digital signal through an A/D converter (not illustrated).

The ECU 905 may compare the converted digital signal with pre-stored driving conditions such as an emergency stop and a rear-end collision.

When the first signal matches one of the driving conditions (e.g., an emergency stop), the ECU 905 may transmit a second signal corresponding to emergency stop to the black box 910 through an in-vehicle network 901, and may control the brake system according to the emergency stop condition.

The black box 910 may generate warning information corresponding to the second signal indicating the emergency stop and transmit the warning information to a second vehicle 1000 or server 1100 (as illustrated in FIG. 10) through an out-vehicle network 902.

Next, a description is given of the vehicle 900 according to an exemplary embodiment.

FIG. 10 is a block diagram of vehicles according to an exemplary embodiment of the present invention.

Referring to FIG. 10, a vehicle 900 may connect to an out-vehicle network 902, and may connect through the out-vehicle network 902 to a second vehicle 1000, a server 1100 or a portable appliance 1150.

The portable appliance 1150 may be any portable device, such as a mobile terminal, a smart phone, an electronic book (e-book) reader, a laptop a computer, a tablet personal computer or a portable storage media like a Universal Serial Bus (USB) memory or memory card.

The server 1100 may provide various services, such as stock quotes, news, weather information or Video On Demand (VOD) streaming, to the driver of the vehicle 900.

The server 1100 may receive vehicle information including vehicle location, distance traveled, driving speed, a registration number, an engine state and a transmission state from the vehicle 900. The server 1100 may transmit management information (e.g., an engine examination notification) corresponding to the vehicle information to the vehicle 900.

The server 1100 may provide a search service enabling the driver of the vehicle 900 to find a nearby restaurant or a cheap gas station during driving.

In the following description, the second vehicle 1000, the server 1100 and the portable appliance 1150 may be referred to as an “external equipment”.

The vehicle 900 may include an ECU 905, a black box 910, a brake pedal switch 922, a speed sensor 952, a GPS receiver 960, a warning facility 970 (e.g., a display unit 971 and a speaker 972), and an input unit 973. Some components of the vehicle 900 are similar to corresponding components of the vehicle 100 described before, and thus only components having a different structure or function will be described below.

When the driver of the vehicle 900 steps on the brake pedal 920, at least one sensor may transmit a first signal indicating braking of the vehicle 900 to the ECU 905.

For example, the brake pedal switch 922 may transmit a first signal indicating brake pedal pressure to the ECU 905, the speed sensors 952 may transmit multiple first signals indicating deceleration of the wheels 950 by braking to the ECU 905, or both the brake pedal switch 922 and the speed sensors 952 may transmit first signals to the ECU 905.

The first signals transmitted by the speed sensors 952 may have different magnitudes according to rotations of the corresponding wheels 950.

The speed sensor 952 may sense a voltage signal generated by the pulser 953 rotating with the wheel 950 and transmit the sensed voltage signal to the ECU 905 as a first signal.

The ECU 905 may compute the rate of rotation of the wheel 950 (i.e., driving speed of the vehicle 900) based on voltage signals generated for 1 second.

Any sensor capable of sensing rotation of the wheel 950 may be utilized as the speed sensor 952.

When the driver steps on the brake pedal 920, the brake pedal switch 922 is turned on and an “on” signal corresponding to the brake pedal pressure is transmitted to the ECU 905 as a first signal. The ECU 905 may be aware of braking of the vehicle 900 based on an “on” signal from the brake pedal switch 922.

When the driver slowly releases the brake pedal 920, an “off” signal from the brake pedal switch 922 may be transmitted to the ECU 905 as a first signal or a first signal from the speed sensor 952 may be transmitted.

The ECU 905 may be aware of a breaking release based on an “off” signal from the brake pedal switch 922 or a first signal from the speed sensor 952.

The brake pedal switch 922 and the speed sensor 952 may be connected to the ECU 905 through wired communication and/or wireless communication based on RFID or Bluetooth.

The ECU 905 may convert a first signal (e.g., an analog signal) input from the speed sensor 952 or brake pedal switch 922 into a digital signal through an A/D converter (not illustrated).

The ECU 905 may compare the converted digital signal with pre-stored driving conditions such as driving speed, deceleration, braking and an emergency stop.

For example, when the speed of the vehicle 900 is 80 km/h at time t and is 70 km/h at time t+1, the vehicle 900 is decelerated by 10 km/h. Here, t may be an integer in units of seconds.

An emergency stop may indicate a case in which the vehicle 900 is decelerated by 25.2 km/h or more from a speed of 55 km/h or more. The criteria for determining the emergency stop may differ according to nations and manufacturers.

The driving conditions associated with the vehicle 900 being driven may be stored in a look-up table.

The driving conditions may include transmission conditions (such as braking, an emergency stop and a rear-end collision) for generating warning information that is to be transmitted from the ECU 905 to the black box 910.

When a digital signal matches one of the transmission conditions (e.g., an emergency stop), the ECU 905 may transmit a second signal indicating the emergency stop to the black box 910 through the in-vehicle network 901.

The ECU 905 may be connected with multiple sensors (not illustrated) for sensing states of the engine, transmission and sashes of the vehicle 900.

The ECU 905 may examine states of the vehicle 900 using multiple signals from different sensors and control the vehicle 900 according to the examination results.

For example, the ECU 905 may convert a first signal from a crash sensor (not illustrated) into a digital signal.

The ECU 905 may compare the converted digital signal with preset driving conditions such as airbag inflation.

When the first signal matches one of the driving conditions (e.g., airbag inflation), the ECU 905 may transmit a second signal corresponding to airbag inflation to the black box 910 through the in-vehicle network 901.

When one of preset driving conditions such as braking, an emergency stop and airbag inflation is met, the ECU 905 may transmit both a corresponding second signal and vehicle state information to the black box 910.

The driving conditions may be changed (e.g., added, deleted or modified) according to settings of the vehicle 900.

More than one ECU may be installed in the vehicle 900. For example, an engine ECU for managing the engine of the vehicle 900, an airbag ECU for managing airbags and a brake ECU for managing the brake system may be present. Each ECU may transmit a corresponding signal to the black box 910 using the in-vehicle network 901.

The in-vehicle network 901 may be built using wired communication based on a CAN or using wireless communication based on RFID or Bluetooth.

The in-vehicle network 901 may be used to transmit a second signal corresponding to a first signal input to the ECU 905 to the black box 910, and is not limited thereto.

The ECU 905 and the black box 910 may be configured as a single entity. In this case, the ECU 905 may be included as an element in the black box 910.

When the ECU 905 and the black box 910 are configured as a single entity, they may be connected through an internal bus as opposed to being connected through the in-vehicle network 901.

The black box 910 is a device for producing warning information or a warning message.

The black box 910 may include an input/output unit 911, a control unit 912, a driving direction determiner 913, a frequency determiner 914, a warning information generator 915, a transceiver unit 916, a warning information analyzer 917, a warning message generator 918 and an HDD 919. Some components of the black box 910 are similar to corresponding components of the black box 120 described before, and thus only components having a different structure or function will be described below.

The frequency determiner 914 may determine a transmission frequency to transmit warning information regarding the vehicle 900.

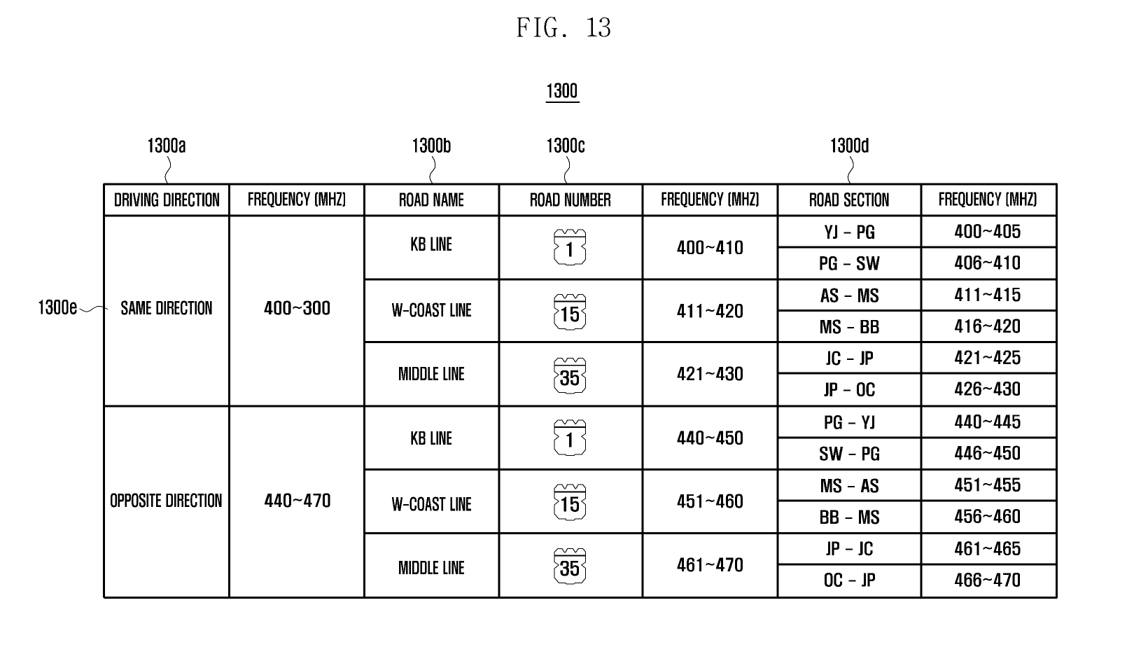

A transmission frequency may be determined using a transmission frequency table 1300 (as illustrated in FIG. 13) stored in the storage. The transmission frequency table 1300 may be pre-stored at the time of manufacture or may be received from an external equipment. Entries of the transmission frequency table 1300 may be changed (e.g., added, removed or updated) according to the current location or settings of the vehicle 900.

FIG. 13 illustrates a transmission frequency table according to an exemplary embodiment of the present invention.

Referring to FIG. 13, a transmission frequency may be determined in the transmission frequency table 1300 utilizing at least one of a driving direction 1300a (corresponding to the location information of the vehicle 900), road name 1300b, road number 1300c, and road section 1300d.

For example, a transmission frequency may be determined using the driving direction 1300a, using the driving direction 1300a and road name 1300b, or using the driving direction 1300a, road name 1300b and road section 1300d.

The black box 910 may determine a transmission frequency according to the driving direction and transmit warning information using the determined transmission frequency. In this case, other vehicles driving in the same direction may receive the warning information from the vehicle 900, and other vehicles driving in the opposite direction cannot receive the warning information because of a frequency difference.

When a transmission frequency commonly available to both directions is selected, the black box 910 may transmit warning information to other vehicles driving in the opposite direction.

The warning information generator 915 may generate warning information that is to be transmitted in a given direction using a determined transmission frequency.

The generated warning information may contain a black box model name, a frame number, a vehicle type (e.g., a bus, a taxi, a two-wheeled vehicle, a truck, and the like), a registration number, a location information of the vehicle 900, a warning type (e.g., an emergency stop or a rear-end collision), a driving direction, and a warning occurrence time.

A format of warning information is illustrated in Table 2.

TABLE 2

| Field | Bits |
|---|---|
| Warning type | 3 |
| Vehicle type | 3 |
| Location information | 10 |
| Driving direction | 1 |
| Warning occurrence time | 10 |

For example, in Table 2, the warning type may be set to “000” and “010” for “emergency stop” and “rear-end collision”, respectively. The vehicle type may be set to “001”, “010” and “011” for “bus”, “taxi”, and “two-wheeled”, respectively. The location information indicates location information of the vehicle 900 obtained using GPS satellites. The driving direction may be set to “0” or “1” for same direction or opposite direction, respectively. The warning occurrence time indicates the time at which a warning condition has been triggered.

In Table 2, lengths of fields are not fixed and may be changed, and may be in units of bits or bytes.

The warning information generator 915 may generate warning information using all or some of the items of Table 2 or using additional items. The warning information may have a variable number of items.

The warning information generator 915 may generate warning information utilizing all or some data items provided by the vehicle 900.

In the following description, the terms “warning type” and “transmission condition” may be used interchangeably.

The warning information may be in an image format, a text format or a sound format.

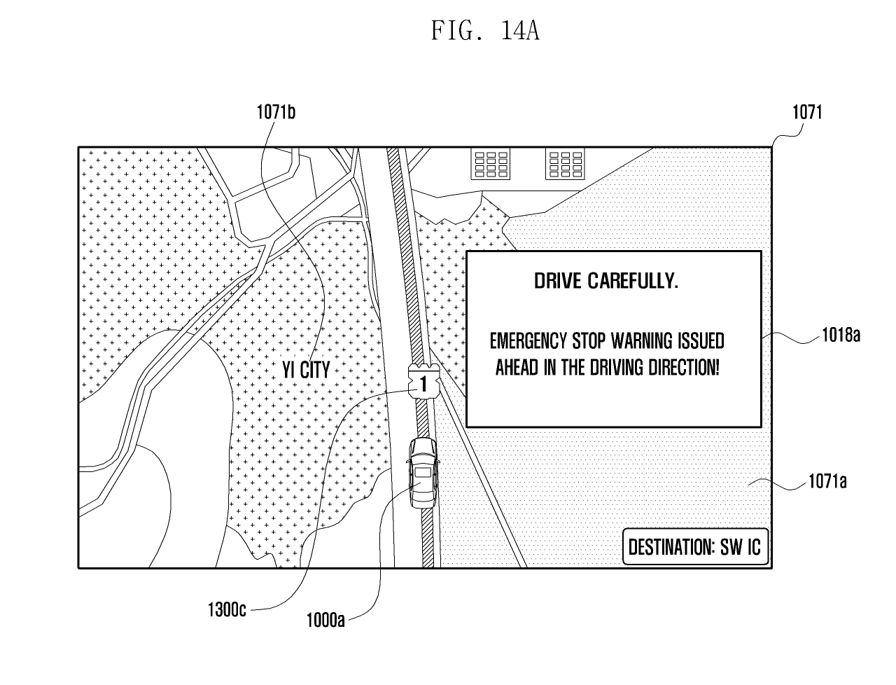

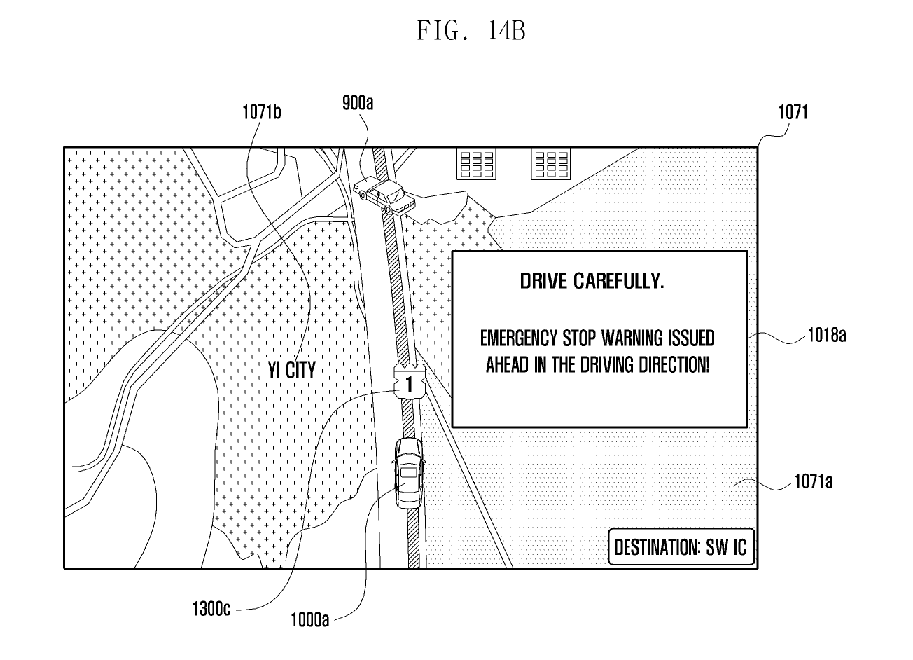

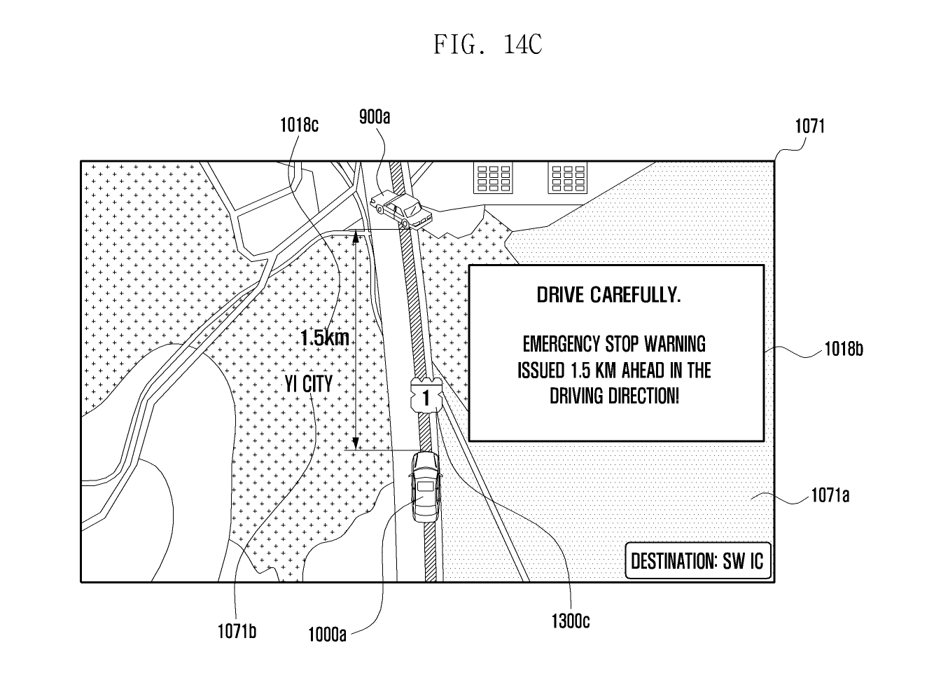

Image format warning information may be a bitmap image or a vector graphic image. When image format warning information is received by the second vehicle 1000, it may be processed into a warning message 1018a (as illustrated in FIG. 14A), which is then displayed on a display unit 1071 for the driver.

Text format warning information may have an extension like “txt” or “rtf”. When text format warning information is received by the second vehicle 1000, it may be processed into a warning message 1018a, which is then provided to the driver in image or text form.

Sound format warning information may have an extension like “wav”, “voc”, “mid” or “mp3”. When the sound format warning information is received by the second vehicle 1000, it may be provided to the driver through a speaker 1072.

A warning message 918a corresponding in format to the warning information may be provided to the driver of the second vehicle 1000 through a warning facility 1070.

The image, the text or the sound format warning information may contain metadata.

The format of the warning information may be changed according to settings of the vehicle 900. The vehicle 900 may transmit a query for available warning information formats to the second vehicle 1000, and receive a corresponding response from the second vehicle 1000, and transmit warning information in a responding format to the second vehicle 1000.

The warning information generator 915 may generate a warning message of an image, a text or a sound format corresponding to warning information to be transmitted to the second vehicle 1000.

When a warning message generated by the warning information generator 915 is transmitted to the second vehicle 1000, a warning information analyzer 1017 of the second vehicle 1000 analyzes the received warning message and the analyzed warning message is provided to the driver of the second vehicle 1000 through a warning facility 1070.

The transceiver unit 916 may transmit warning information generated by the warning information generator 915 to an external equipment through the out-vehicle network 902.

For transmission, the transceiver unit 916 may use a CDMA scheme, a WCDMA scheme, an LTE scheme, a WiMax scheme, a WiBro scheme and a walkie-talkie style short-range communication according to the distance between the vehicle 900 and second vehicle 1000. For example, when the vehicle 900 is close to the second vehicle 1000, the transceiver unit 916 may use the walkie-talkie style short-range communication. When the vehicle 900 is far from the second vehicle 1000, the transceiver unit 916 may use the CDMA scheme, the WCDMA scheme, the LTE scheme, the WiMax scheme or the WiBro scheme according to settings. Even when the vehicle 900 is close to the second vehicle 1000, the transceiver unit 916 may use the CDMA scheme, the WCDMA scheme, the LTE scheme, the WiMax scheme or the WiBro scheme according to settings.

In the following description, when warning information is created by the vehicle 900, it may be referred to as a warning message 918a. When warning information is created by the second vehicle 1000, it may be referred to as a warning message 1018a.

The transceiver unit 916 may receive warning information from the second vehicle 1000 through the out-vehicle network 902.

The received warning information may be stored in the storage under control of the control unit 912.

The transceiver unit 916 may forward warning information received from the second vehicle 1000 to a third vehicle in the vicinity of the vehicle 900.

The third vehicle may receive the warning information, and a warning message corresponding to the received warning information may be delivered to the driver of the third vehicle in a visual form or a sound form.

In the following description, the warning information analyzer 917 and the warning message generator 918 of the vehicle 900 may correspond respectively to a warning information analyzer 1017 and the warning message generator 1018 of a second vehicle 1000 having received warning information transmitted from the vehicle 900.

The warning information analyzer 917 may analyze warning information received from the second vehicle 1000.

The received warning information may contain a black box model name of the second vehicle 1000, a frame number, a vehicle type (e.g., a bus, a taxi, a two-wheeled vehicle, a truck, and the like), a registration number, location information of the second vehicle 1000, a warning type (e.g., an emergency stop or a rear-end collision), a driving direction, and a warning occurrence time.

The warning information analyzer 917 may analyze all items of the warning information or selectively analyze high-priority items (such as driving direction and location information) thereof.

Items of the warning information may be used to generate a warning message 918a.

The warning information analyzer 917 may analyze warning information in a manner conforming to the format thereof (e.g., an image, a text or a sound).

The control unit 912 may control the warning message generator 918 to generate a warning message 918a according to the analysis results of the warning information analyzer 917.

The control unit 912 may transmit a signal for deceleration to the ECU 905 through the in-vehicle network 901 according to the analysis results of the warning information.

In response to the deceleration signal from the black box 910, the ECU 905 may control the transmission to decelerate the vehicle 900.

When the driver steps on the brake pedal 920 according to a delivered warning message 918a, at least one sensor detecting deceleration of the vehicle 900 may transmit a first signal to the ECU 905.

The ECU 905 may transmit a second signal corresponding to the first signal to the black box 910 through the in-vehicle network 901.

Upon reception of the second signal, the black box 910 may notify the driver of deceleration of the vehicle 900 in a visual or a sound form through the warning facility 970.

The warning message generator 918 may generate a warning message 918a according to the analysis results of the warning information analyzer 917.

When the driving direction of the vehicle 900 is the same as that of the second vehicle 1000 having transmitted warning information, the warning message generator 918 may generate a warning message 918a based on the warning information.

The warning message 918a may be generated in an image format, a text format or a sound format according to the warning information.

The warning message generator 918 may generate a warning message 918a in a manner conforming to the format of the warning information. For example, when the warning information is in a sound format, the warning message generator 918 may reproduce the warning information to the driver. Here, the reproduced warning information in a sound format becomes a warning message 918a.

The warning message generator 918 may generate a warning message 918a using all or some items of received warning information.

The generated warning message 918a may be delivered to the driver of the vehicle 900 in at least one of a visual form and a sound form.

The HDD 919 may store a second signal from the ECU 905 and state information of the vehicle 900 under control of the control unit 910. The HDD 919 may store location information from the GPS receiver 960.

The HDD 919 may also store warning information to be transmitted through the transceiver unit 911, warning information received from the second vehicle 1000, and a warning message 918a generated by the warning message generator 918.

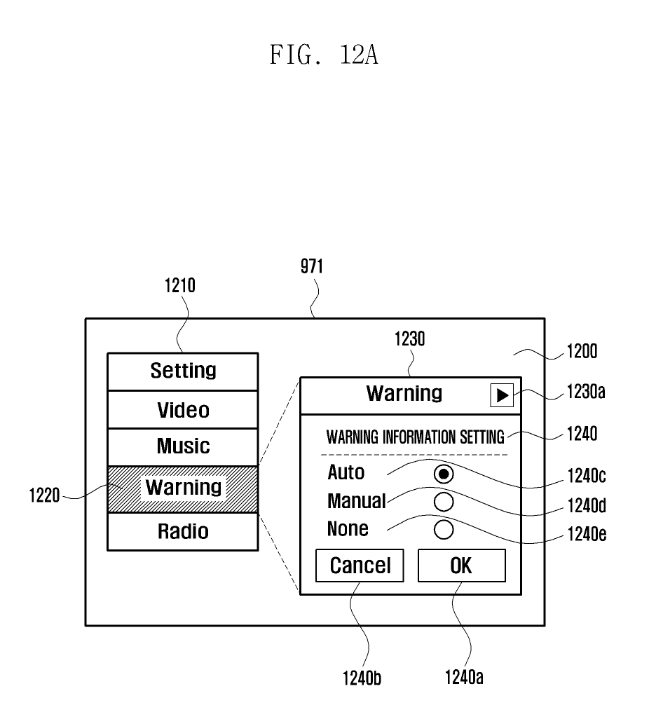

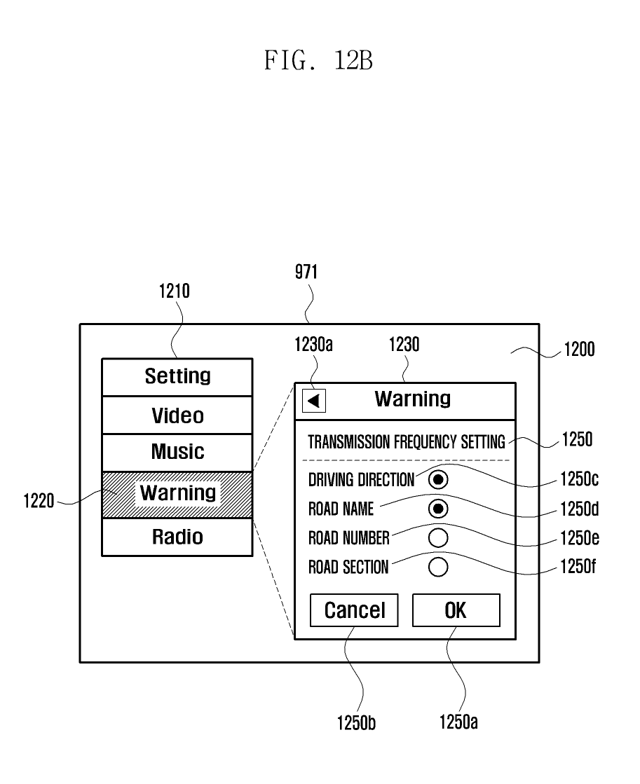

The display unit 971 may display various service screens related to, for example, a navigation map, Internet browsing and DMB reception. The display unit 971 may display a warning message 918a and a user interface screen 1200 to receive driver settings corresponding to warning information (FIGS. 12A and 12B).

When a navigation map is displayed on the display unit 971, a generated warning message 918a may be displayed as a popup on the navigation map.

On the navigation map of the display unit 917, an icon 900a for the vehicle 900 and an icon 1000a for the second vehicle 1000 may be displayed in addition to a popup of a warning message 918a.

On the navigation map of the display unit 917, an icon 900a for the vehicle 900, an icon 1000a for the second vehicle 1000 and a distance between the vehicle 900 and the second vehicle 1000 may be displayed in addition to a popup of a warning message 918a.

The speaker 972 produces various sounds related to, for example, music, navigation and warning messages 918a.

The speaker 972 may produce synthesized sounds corresponding to a warning message 918a or a high-pitched sound such as the sound of squealing tires or a collision sound to alert the driver.

The warning facility 970 may be composed of the display unit 971 and the speaker 972.

When a warning message 918a is in a visual form (e.g., an image format or a text format), it may be delivered to the driver through the display unit 971. When a warning message 918a is in a sound form, it may be delivered through the speaker 972.

When a warning message 918a is in a visual and sound form, it may be delivered through both the display unit 971 and the speaker 972.

The black box 910 may receive a first signal directly from a sensor through the input/output unit 911 while bypassing the ECU 905.

The black box 910 may bypass the ECU 905 in the case of failure or self-diagnosis of the ECU 905.

The black box 910 may include an ECU unit (not illustrated) that performs an operation corresponding to that of the ECU 905.

The ECU unit may determine whether the received first signal meets a transmission condition, and transmit a corresponding second signal to the black box 910 when the first signal meets a transmission condition.

The black box 910 may generate warning information containing location information and driving direction based on the received second signal, and transmit the warning information to the second vehicle 1000.

The second vehicle 1000 may include an ECU 1005, a black box 1010, a brake pedal switch 1022, a speed sensor 1052, a GPS receiver 1060, a warning facility 1070 including a display unit 1071 and a speaker 1072, and an input unit 1073.

The black box 1010 may include an input/output unit 1011, a control unit 1012, a driving direction determiner 1013, a frequency determiner 1014, a warning information generator 1015, a transceiver unit 1016, a warning information analyzer 1017, a warning message generator 1018 and an HDD 1019.

Components 1001 to 1073 of the second vehicle 1000 are similar to corresponding components 901 to 973 of the vehicle 900, and thus a detailed description thereof is omitted.

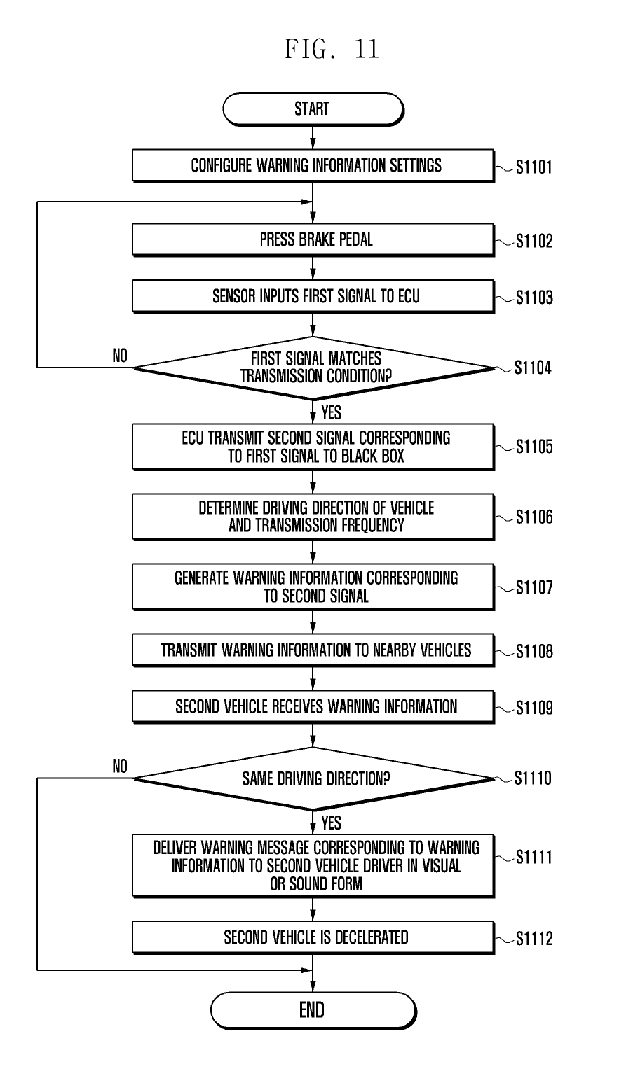

FIG. 11 is a flowchart of a warning providing method for the vehicle according to an exemplary embodiment of the present invention.

Referring to FIG. 11, the vehicle 900 receives settings for warning information provision from the driver at step S1101.

FIGS. 12A and 12B illustrate user interface screens for setting the warning providing method according to an exemplary embodiment of the present invention.

Referring to FIG. 12A, a setting window 1210 is displayed on a user interface screen 1200 on the display unit 971 of the vehicle 900.

The setting window 1210 may include a “video” item, a “music” item, a “warning” item 1220 and a “radio” item. When a down direction key (not illustrated) below the “radio” item is selected, additional items of the setting window 1210 may be displayed. Items of the setting window 1210 may be changed (e.g., added, deleted or updated) according to functions of the vehicle 900.

When the “warning” item 1220 is selected, a “warning” window 1230 containing a “warning information setting” item 1240 is displayed near the selected item 1220. When a right direction key 1230a of the “warning” window 1230 is selected, additional items of the “warning” window 1230 may be displayed.

The “warning information setting” item 1240 may have an “auto” (automatic) option 1240c, a “manual” option 1240d and a “none” option 1240e.

The “auto” option 1240c indicates that warning information is automatically generated and transmitted to a second vehicle 1000 without explicit driver selection. The “manual” option 1240d indicates that warning information is generated and transmitted to a second vehicle 1000 after explicit driver selection, and the “none” option 1240e indicates that warning information is not generated.

In FIG. 12A, the “auto” option 1240c of the “warning information setting” item 1240 is selected. When the driver selects an “OK” button 440a, warning information setting is confirmed. When the driver selects a “cancel” button 440b, warning information setting is aborted.

When the right direction key 1230a of the “warning” window 1230 is selected, a “transmission frequency setting” item 1250 may be displayed as illustrated in FIG. 12B.

The “transmission frequency setting” item 1250 may have options 1250c to 1250f for selecting a transmission frequency to be used to transmit warning information.

At least one option including driving direction 1250c, road name 1250d, road number 1250e, and road section 1250f may be selected.

For example, a transmission frequency may be selected using the driving direction 1250c only, using the driving direction 1250c and the road name 1250d, using the driving direction 1250c, the road name 1250d and the road section 1250f, or using the driving direction 1250c, the road name 1250d and the road number 1250e.

Other options for selecting a transmission frequency may be specified when available to the vehicle 900.

Another user interface screen may be provided to show mappings between available options and transmission frequencies.

In FIG. 12B, the driving direction 1250c and road name 1250d of the “transmission frequency setting” item 1250 are selected. When the driver selects an “OK” button 1250a, “transmission frequency setting” is confirmed. When the driver selects a “cancel” button 1250b, “transmission frequency setting” is aborted.

Referring back to FIG. 11, the driver of the vehicle 900 steps on the brake pedal 920 while driving at step S1102.

Brake pedal pressure causes the master cylinder 921 and ABS hydraulic unit 940 to apply hydraulic pressure to the wheels 950. Thereby, the vehicle 900 is slowed or suddenly stopped.

A first signal is input from a sensor of the vehicle 900 to the ECU 905 at step S1103.

At least one of sensors including the brake pedal switch 922 and speed sensors 952 of the wheels 950 may transmit a first signal indicating braking of the vehicle 900 to the ECU 905.

For example, the brake pedal switch 922 of the brake pedal 920 may transmit a first signal to the ECU 905, the speed sensors 952 of the wheels 950 may transmit multiple first signals to the ECU 905, or both the brake pedal switch 922 and the speed sensors 952 may transmit first signals to the ECU 905.

Any other sensor capable of detecting braking of the vehicle 900 may transmit a first signal to the ECU 905.

The ECU 905 determines whether the first signal satisfies one of the transmission conditions at step S1104.

The transmission conditions may include an emergency stop, a rear-end collision and failure such as a tire blowout. Transmission conditions may be set using a user interface screen (not illustrated) displayed on the display unit 971.

At step S1104, the first signal is assumed to satisfy a transmission condition of emergency stop. However, satisfaction of another transmission condition may also be possible.

For example, when the second signal indicates that the speed of the vehicle 900 is 80 km/h at time t and is decreased to 50 km/h at time t+1, the ECU 905 may determine that the emergency stop transmission condition is met (here, t is an integer in units of seconds). The criteria for determining an emergency stop may be different according to nations and manufacturers.

When the first signal does not satisfy a transmission condition, the process is returned to step S1102.

When the first signal satisfies a transmission condition, the ECU 905 transmits a second signal corresponding to the first signal to the black box 910 at step S1105.

The ECU 905 transmits a second signal indicating an emergency stop to the black box 910 through the in-vehicle network 901.

The in-vehicle network 901 may be built using wired communication based on a CAN or using wireless communication based on RFID or Bluetooth.

Any communication scheme capable of transmitting a second signal from the ECU 905 to the black box 910 may be utilized for the in-vehicle network 901.

The black box 910 determines the driving direction of the vehicle 900 and a transmission frequency at step S1106.

In response to reception of the second signal indicating emergency stop from the ECU 905, the black box 910 may determine the driving direction of the vehicle 900 and a transmission frequency to transmit warning information.

The black box 910 may receive location information of the vehicle 100 from the GPS receiver 906, store the location information in the storage, and update the stored location information at regular intervals.

The black box 910 may determine the driving direction of the vehicle 900 using the updated location information (i.e., the path of the vehicle 900) and a pre-stored digital map.

The black box 910 may determine a transmission frequency to be used to transmit warning information.

FIG. 13 illustrates a transmission frequency table, which contains transmission frequencies for an out-vehicle network to transmit warning information according to an exemplary embodiment of the present invention.

Referring to FIG. 13, the transmission frequency table 1300 may include fields for a driving direction 1300a (corresponding to the location information of the vehicle 900), a road name 1300b, a road number 1300c, and a road section 1300d.

As described in FIG. 12B, the driving direction 1250c and the road name 1250d of the “transmission frequency setting” item 1250 are selected from the user interface screen 1200.

For example, referring to FIGS. 12B and 13, in the transmission frequency table 1300, when the road name 1300b is “KB line” (road number 1) and the driving direction 1300a is “same direction 1300e” (driving direction of the vehicle 900), transmission frequencies of 400 to 410 MHz are determined.

When the road name 1300b is “Middle line” (road number 35) and the driving direction 1300a is “same direction 1300e”, transmission frequencies of 421 to 430 MHz are determined.

In the transmission frequency table 1300, different transmission frequencies may be assigned according to driving directions of vehicles.

Hence, when the second vehicle 1000 is driven in a direction opposite to that of the vehicle 900 on the same road, the second vehicle 1000 may be unable to receive warning information from the vehicle 900.

The transmission frequency table 1300 may be pre-stored in the storage of the vehicle 900, and may also be received (while being driven or parked) from an external equipment through the out-vehicle network 902.

Instead of using the stored transmission frequency table 1300, the black box 910 may transmit a query request for transmission frequency information through the out-vehicle network 902 to the second vehicle 1000 (or the server 1100), and receive transmission frequency information from the second vehicle 1000 through the out-vehicle network 902.

The black box 910 may determine a transmission frequency using the received transmission frequency information.

The black box 910 generates warning information corresponding to the second signal at step S1107.

The black box 910 may generate warning information to be transmitted to the second vehicle 1000 utilizing the determined driving direction and transmission frequency.

Items of the warning information may be changed or updated.

The warning information may be generated utilizing all or some data items provided by the vehicle 900.

The warning information may be in an image format, a text format or a sound format. The format of the warning information may be changed according to settings of the vehicle 900.

The black box 910 may transmit a query for available warning information formats to a second vehicle 1000, and receive a corresponding response from the second vehicle 1000, and transmit warning information in a responding format to the second vehicle 1000.

The black box 910 transmits the generated warning information to an external equipment at step S1108.

The warning information may be transmitted through the transceiver unit 916 and the out-vehicle network 902 to an external equipment (the second vehicle 1000 or the server 1100 in the vicinity of the vehicle 900).

In the following description, the words “nearby”, “close to” or “vicinity” may be used in relation to a coverage area of short-range wireless communication.

The warning information may be transmitted to the external equipment using various communication schemes supported by the transceiver unit 916 and the out-vehicle network 902, such as a CDMA scheme, a WCDMA scheme, an LTE scheme, a WiMax scheme, a WiBro scheme and short-range wireless communication.

When the transceiver unit 916 supports one communication scheme, the warning information may be transmitted using the supported communication scheme. When the transceiver unit 916 supports multiple communication schemes, the warning information may be transmitted using one of the supported communication schemes.

The transceiver unit 916 may transmit warning information using various transmission schemes according to the distance between the vehicle 900 and second vehicle 1000 or between the vehicle 900 and the server 1100.

For example, when the vehicle 900 is close to the second vehicle 1000 (e.g., within 5 Km), the transceiver unit 916 may use walkie-talkie style short-range wireless communication to transmit warning information.

When the vehicle 900 is far from the second vehicle 1000 (e.g., more than 5 Km), the transceiver unit 916 may use the CDMA scheme, the WCDMA scheme, the LTE scheme, the WiMax scheme or the WiBro scheme to transmit warning information.

The black box 910 may determine a transmission frequency according to the driving direction and transmit warning information using the determined transmission frequency. In this case, other vehicles driving in the same direction may receive the warning information from the vehicle 900, and other vehicles driving in the opposite direction cannot receive the warning information because of a frequency difference.

When a transmission frequency commonly available to both directions is selected, the black box 910 may transmit warning information to other vehicles driving in the opposite direction.

The second vehicle 1000 receives the warning information from the vehicle 900 at step S1109.

The second vehicle 1000 may receive the warning information from the out-vehicle network 902 through the transceiver unit 1016. In the second vehicle 1000, the received warning information may be stored in the storage under control of the control unit 1072.

The black box 1010 may forward the received warning information to a third vehicle (not illustrated) in the vicinity of the second vehicle 1000.

In the third vehicle, a warning message corresponding to the received warning information may be provided to the driver in a visual form or a sound form.

The black box 1010 determines whether the driving direction is the same as that of the vehicle 900 based on the warning information at step S1110.

As to the vehicle 900, a vehicle type, location information, a warning type, driving direction, and a warning occurrence time may be identified using the warning information.

When the driving direction is the same as that of the vehicle 900, the black box 1010 may generate a warning message 1018a corresponding to the warning information. When the driving direction is not the same as that of the vehicle 900, the black box 1010 may ignore the warning information and end the process.

When the location of the vehicle 900 is ahead of that of the second vehicle 1000 in the same driving direction, the black box 1010 may generate a warning message 1018a corresponding to the warning information.

When the location of the vehicle 900 is behind that of the second vehicle 1000 in the same driving direction, the black box 1010 may ignore the warning information and end the process.

The black box 1010 delivers the generated warning message 1018a to the driver of the second vehicle 1000 in at least one of a visual form and a sound form at step S1111.

The warning message 1018a may be delivered to the driver in a visual form, in a sound form or in a sound and visual form.

The warning message 1018a may be generated in an image format, a text format or a sound format according to the warning information. The warning information may be directly delivered to the driver as a warning message 1018a without conversion.

FIGS. 14A to 14C illustrate provision of warning messages to the driver of the second vehicle 1000 according to an exemplary embodiment of the present invention.

Referring to FIG. 14A, a region name 1071b (“YI city”), an icon 1000a representing the second vehicle 1000, and a warning message 1018a are presented on a navigation map 1071a of the display unit 1071.

The location of the icon 1000a may be obtained using location information from the GPS receiver 1060.

The navigation map 1071a indicates that the destination of the second vehicle 1000 is “SW IC” and the second vehicle 1000 is driven near “YI city” in a direction toward “BS” of “KB line” (load number 1).

When warning information is received, the black box 1010 may verify the driving direction indicated by the warning information and, when the indicated driving direction is the same as that of the second vehicle 1000, display a corresponding warning message 1018a on the display unit 1071.

In FIG. 14A, an alert phrase (“Drive carefully! Emergency stop warning issued ahead in the driving direction.”) is contained in the warning message 1018a. The distance between the vehicle 900 and second vehicle 1000 may also be contained in the warning message 1018a.

The format of an alert phrase contained in a warning message 1018a may be changed according to the type of the warning message 1018a. In FIG. 14C, a warning message 1018a containing an alert phrase of a different format is displayed.

The warning message 1018a may be presented as a popup on the navigation map 1071a. The warning message 1018a and the navigation map 1071a may overlap on the display unit 1071, and a transparency of 0 to 100 percent may be assigned to the warning message 1018a being overlapped.

The warning message 1018a may be displayed for a preset time (e.g., for five seconds or until arrival at the warning location of the vehicle 900) on the display unit 1071.

The size and position of the warning message 1018a being displayed may be changed according to settings for user interface screens on the display unit 1071.

The speaker 1072 may produce synthetic sounds corresponding to the warning message 1018a or a high-pitched sound such as the sound of squealing tires to alert the driver.

Referring to FIG. 14B, a region name 1071b, an icon 900a representing the vehicle 900, an icon 1000a representing the second vehicle 1000, and a warning message 1018a are presented on a navigation map 1071a of the display unit 1071.

The location of the icon 900a may be obtained using the warning information from the vehicle 900 and location information from the GPS receiver 1060.

In FIG. 14B, an alert phrase (“Drive carefully! Emergency stop warning issued ahead in the driving direction.”) is contained in the warning message 1018a. The distance between the vehicle 900 and second vehicle 1000 may also be contained in the warning message 1018a.

The warning message 1018a and the icon 900a may be displayed for a preset time (e.g., for five seconds or until arrival at the warning location of the vehicle 900).

The size and position of the warning message 1018a being displayed may be changed in relation to the size and location of the icon 900a of the vehicle 900.

The size and position of the warning message 1018a being displayed may be changed in relation to the size and location of the region name 1071b on the display unit 1071.

The speaker 1072 may produce synthetic sounds corresponding to the warning message 1018a or a high-pitched sound such as the sound of squealing tires to alert the driver.

Referring to FIG. 14C, a region name 1071b, an icon 900a representing the vehicle 900, an icon 1000a representing the second vehicle 1000, a warning message 1018b and a distance 1018c between the vehicle 900 and second vehicle 1000 are presented on a navigation map 1071a of the display unit 1071.

The locations of the icon 900a and the icon 1000a in relation to the distance 1018c between the vehicle 900 and second vehicle 1000 may be obtained using the warning information from the vehicle 900 and location information from the GPS receiver 1060.

In FIG. 14C, the distance between the vehicle 900 and second vehicle 1000 (e.g., 1.5 km) may be contained in an alert phrase of the warning message 1018b.

The warning message 1018b, the icon 900a and the distance 1018c may be displayed for a preset time (e.g., for five seconds or until arrival at the warning location of the vehicle 900).

The size and position of the warning message 1018b may be changed in relation to the size and location of the icon 900a of the vehicle 900. The size and position of the warning message 1018b being displayed may also be changed in relation to the size and location of the icon 1000a of the second vehicle 1000.

The size and position of the warning message 1018b being displayed may be changed according to the distance 1018c between the vehicle 900 and second vehicle 1000. The size and position of the warning message 1018b being displayed may also be changed in relation to the size and location of the region name 1071b on the display unit 1071.

The speaker 1072 may produce synthetic sounds corresponding to the warning message 1018b or a high-pitched sound such as the sound of squealing tires to alert the driver.

Display settings for FIGS. 14A to 14C may be configured using a user interface screen on the display unit 1071 of the second vehicle 1000.

Referring back to FIG. 11, the second vehicle 1000 is decelerated according to the warning information at step S1112.

The black box 1010 may transmit a deceleration signal corresponding to the received warning information to the ECU 1005 through the in-vehicle network 1001.

The ECU 1005 may decelerate the second vehicle 1000 by controlling the transmission (not illustrated) of the second vehicle 1000 according to the deceleration signal from the black box 1010.

At least one sensor detecting deceleration of the second vehicle 1000 may transmit a first signal to the ECU 1005.

The ECU 1005 may transmit a second signal corresponding to the first signal to the black box 1010.

Upon reception of the second signal, the black box 1010 may notify the driver of deceleration of the second vehicle 1000 in a visual or sound form.

After the deceleration of the second vehicle 1000 at step S1112, the warning method ends.

In an exemplary implementation, one vehicle can transmit vehicle state information to other vehicles through wireless communication. Hence, other vehicles may reduce their driving speed or change their course of driving according to the vehicle state information.

According to exemplary embodiments of the present invention, the methods described above may be implemented as computer programs and may be stored in various computer readable storage media. The computer readable storage media may store program instructions, data files, data structures and combinations thereof. The program instructions may include instructions developed specifically for the present invention and existing general-purpose instructions.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An information providing method for vehicles, the method comprising:
determining a vehicle state based on sensing signals from at least one sensor installed on a vehicle;
generating a state information through analysis of the vehicle state; and
transmitting the state information to a second vehicle.

2. The method of claim 1, wherein the state information comprises a sensor identifier and a sensor state.

3. The method of claim 1, wherein the generating of the state information comprises:
determining a driving information class indicating an emergency or a non-emergency of the vehicle by comparing the vehicle state with pre-stored conditions; and
generating driving information comprising the driving information class and driving direction of the vehicle, as the state information.

4. The method of claim 3, wherein the at least one sensor comprises a collision detection sensor, an airbag sensor, a fire detection sensor, a flat tire sensor and a fuel sensor.

5. The method of claim 3, wherein the driving information further comprising location information and driving speed of the vehicle.

6. The method of claim 3, wherein the transmitting of the state information comprises transmitting the driving information to the second vehicle via a server.

7. The method of claim 3, further comprising receiving an action result for the emergency class driving information based on an analysis of at least one of driving information and an emergency message.

8. The method of claim 7, wherein the action result comprises a vehicle location, a road name, driving direction, an emergency type, an emergency handling status, an expected arrival time of a first aid vehicle and expected completion time of emergency handling.

9. The method of claim 1, wherein the generating of the state information comprises generating warning information indicating deceleration of the vehicle, as the state information, by comparing the vehicle state with pre-stored conditions.

10. The method of claim 9, wherein the at least one sensor comprises a brake pedal switch and a speed sensor.

11. An information providing apparatus for a vehicle, the apparatus comprising:
at least one sensor for generating sensing signals for the vehicle;
an Electronic Control Unit (ECU) for determining a vehicle state based on the sensing signals from the at least one sensor; and
a black box for generating state information through analysis of the vehicle state and for transmitting the state information to a second vehicle.

12. The method of claim 11, wherein the state information comprises a sensor identifier and a sensor state.

13. The apparatus of claim 11, wherein the black box comprises:
a determination unit for determining a driving information class indicating an emergency or a non-emergency of the vehicle and driving direction thereof by comparing the vehicle state with pre-stored conditions; and
a generation unit for generating driving information comprising the driving information class and driving direction as the state information.

14. The apparatus of claim 13, wherein the at least one sensor comprises a collision detection sensor, an airbag sensor, a fire detection sensor, a flat tire sensor and a fuel sensor.

15. The apparatus of claim 13, wherein the driving information further comprises location information and driving speed of the vehicle.

16. The apparatus of claim 13, wherein the black box transmits the driving information to the second vehicle via a server.

17. The apparatus of claim 13, further comprising a transceiver unit for receiving an action result for the emergency class driving information based on an analysis of at least one of driving information and an emergency message.

18. The apparatus of claim 17, wherein the action result comprises a vehicle location, a road name, driving direction, an emergency type, an emergency handling status, an expected arrival time of a first aid vehicle and expected completion time of emergency handling.

19. The apparatus of claim 11, wherein the black box comprises a generation unit for generating warning information indicating deceleration of the vehicle, as the state information, by comparing the vehicle state with pre-stored conditions.

20. The apparatus of claim 19, wherein the at least one sensor comprises a brake pedal switch and a speed sensor.
